(19) United States
(12) Patent Application Publication
(10) Pub. No.: US 2024/0319919 A1
(43) Pub. Date: Sep. 26, 2024

(54) MEMORY SYSTEM AND METHOD FOR CONTROLLING NON-VOLATILE MEMORY

(71) Applicant: Kioxia Corporation, Minato-ku, Tokyo (JP)

(72) Inventors: Yongbum PARK, Minato Tokyo (JP); Shinichi MATSUKAWA, Shinagawa Tokyo (JP)

(73) Assignee: Kioxia Corporation, Minato-ku, Tokyo (JP)

(21) Appl. No.: 18/590,194

(22) Filed: Feb. 28, 2024

(30) Foreign Application Priority Data
Mar. 20, 2023 (JP) 2023-044749

(51) Int. Cl. G06F 3/06

(52) U.S. Cl. CPC G06F 3/0659; G06F 3/0604; G06F 3/0679

(57) ABSTRACT

A memory system includes a non-volatile memory with a plurality of pages; and a memory controller configured to write a plurality of data portions into the non-volatile memory, wherein the data portions are specified based on a plurality of write commands received from a host, respectively. The host assigns same setting information to the plurality of write commands. The memory controller is configured to write the plurality of data portions to a plurality of pages, respectively, wherein the plurality of pages correspond to a plurality of continuous addresses among the plurality of pages based on the same setting information.

### CROSS-REFERENCE TO RELATED APPLICATION

This application is based upon and claims the benefit of priority from Japanese Patent Application No. 2023-044749, filed Mar. 20, 2023, the entire contents of which are incorporated herein by reference.

### FIELD

Embodiments described herein relate generally to a memory system including a non-volatile memory.

### BACKGROUND

In recent years, memory systems including non-volatile memories have widely used. In such a memory system, a NAND flash memory is used as the non-volatile memory.

### DESCRIPTION OF THE DRAWINGS

FIG. 1 is a block diagram showing a configuration of a memory system and a host according to a first embodiment;

FIG. 2 is a diagram showing a configuration of an application file according to the first embodiment;

FIG. 3A is a diagram showing a configuration of an actual data unit and a table unit according to the first embodiment;

FIG. 3B is a diagram showing the configuration of the actual data unit according to the first embodiment;

FIG. 3C is a diagram showing the configuration of the table unit according to the first embodiment;

FIG. 3D is a diagram showing the configuration of the table unit according to the first embodiment;

FIG. 4 is a diagram showing the configuration of the application file according to the first embodiment;

FIG. 5 is a diagram showing the configuration of the actual data unit according to the first embodiment;

FIG. 6 is a diagram showing the configuration of the table unit according to the first embodiment;

FIG. 7A is a diagram showing the configuration of the actual data unit according to the first embodiment;

FIG. 7B is a diagram showing the configuration of the table unit according to the first embodiment;

FIG. 7C is a diagram showing the configuration of the table unit according to the first embodiment;

FIG. 8 is a diagram showing a configuration of a command according to the first embodiment;

FIG. 9A is a diagram showing an example of an operation sequence of the memory system according to the first embodiment;

FIG. 9B is a diagram showing an example of command settings according to the first embodiment;

FIG. 10 is a flowchart showing an operating method of the memory system according to the first embodiment;

FIG. 11 is a diagram showing a configuration of a command according to a second embodiment;

FIG. 12 is a diagram showing an example of application code and data order settings according to the second embodiment;

FIG. 13 is a flowchart showing an operating method of the memory system according to the second embodiment;

FIG. 14 is a flowchart showing the operating method of the memory system according to the second embodiment;

FIG. 15 is a functional block diagram of a memory system and a host according to a third embodiment;

FIG. 16 is a flowchart showing an operating method of the memory system according to the third embodiment;

FIG. 17A is a diagram showing a configuration of a time stamp table according to the third embodiment;

FIG. 17B is a diagram showing a configuration of an actual data unit according to the third embodiment;

FIG. 17C is a diagram showing a configuration of a table unit according to the third embodiment;

FIG. 17D is a diagram showing the configuration of the actual data unit according to the third embodiment;

FIG. 17E is a diagram showing the configuration of the table unit according to the third embodiment;

FIG. 17F is a diagram showing the configuration of the actual data unit according to the third embodiment;

FIG. 17G is a diagram showing the configuration of the table unit according to the third embodiment;

FIG. 18 is a functional block diagram of a memory system and a host according to a fourth embodiment;

FIG. 19 is a diagram showing a configuration of an application file according to the fourth embodiment;

FIG. 20 is a diagram showing a configuration of a command according to the fourth embodiment;

FIG. 21 is a flowchart showing an operating method of the memory system according to the fourth embodiment;

FIG. 22 is a diagram showing an example of command settings according to the fourth embodiment;

FIG. 23 is a diagram showing a configuration of an actual data unit according to the fourth embodiment;

FIG. 24 is a diagram showing a configuration of a table unit according to the fourth embodiment;

FIG. 25 is a functional block diagram of a memory system and a host according to a fifth embodiment;

FIG. 26 is a diagram showing a configuration of an application file according to the fifth embodiment;

FIG. 27 is a flowchart showing an operating method of the memory system according to the fifth embodiment;

FIG. 28A is a diagram showing a configuration of an actual data unit according to a fifth embodiment;

FIG. 28B is a diagram showing a configuration of a table unit according to the fifth embodiment;

FIG. 28C is a diagram showing the configuration of the actual data unit according to the fifth embodiment;

FIG. 28D is a diagram showing the configuration of the table unit according to the fifth embodiment; and

FIG. 29 is a diagram showing the configuration of the table unit according to the fifth embodiment.

### DETAILED DESCRIPTION

Embodiments provide to speed up a read operation of a memory system.

In general, according to one embodiment, a memory system includes a non-volatile memory with a plurality of pages; and a memory controller configured to write a plurality of data portions into the non-volatile memory, wherein the data portions are specified based on a plurality of write commands received from a host, respectively. The host assigns same setting information to the plurality of write commands. The memory controller is configured to write the plurality of data portions to a plurality of pages, respectively, wherein the plurality of pages correspond to a plurality of continuous addresses among the plurality of pages based on the same setting information.

According to one embodiment, a memory system is connectable to a host and includes non-volatile memories each including a plurality of pages, and a memory controller that writes a plurality of pieces of data specified by each of a plurality of write commands each received from the host into the non-volatile memory, in which the host assigns setting information belonging to a same group to each of the plurality of write commands, and the memory controller writes the plurality of pieces of data to a plurality of pages which correspond to a plurality of continuous addresses among the plurality of pages based on the setting information belonging to the same group, and after the writing, the memory controller periodically reads a file system stored in the non-volatile memory, analyzes the file system, and acquires a time stamp included in the file system.

According to one embodiment, a method for controlling a non-volatile memory includes executing a write operation of writing a plurality of pieces of data specified by each of a plurality of write commands each received from a host into the non-volatile memory, in which same setting information is assigned to each of the plurality of write commands, and the write operation includes writing the plurality of pieces of data to a plurality of pages which correspond to a plurality of continuous addresses among the plurality of pages based on the same setting information.

Hereinafter, a memory system of embodiments will be described with reference to the drawings. In the following description, elements having the same or similar functions and configurations are denoted by common reference numerals. When distinguishing a plurality of elements having a common reference number, subscripts (for example, uppercase alphabetic characters, numbers, hyphens and uppercase alphabetic characters and numbers, and the like) may be added to the common reference number to distinguish the elements.

### First Embodiment

A memory system 1 according to a first embodiment will be described. The memory system 1 includes a non-volatile memory 20 and a memory controller 10 that controls the non-volatile memory 20. The non-volatile memory 20 is an example of a semiconductor memory device, and may be a NAND flash memory, for example.

### <1-1. Overall Configuration of Memory System 1>

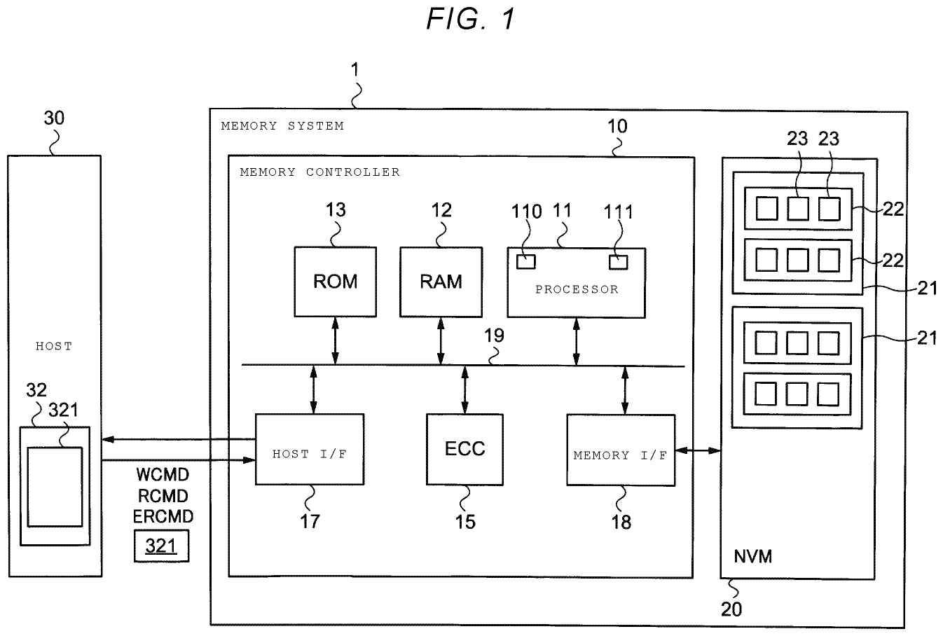

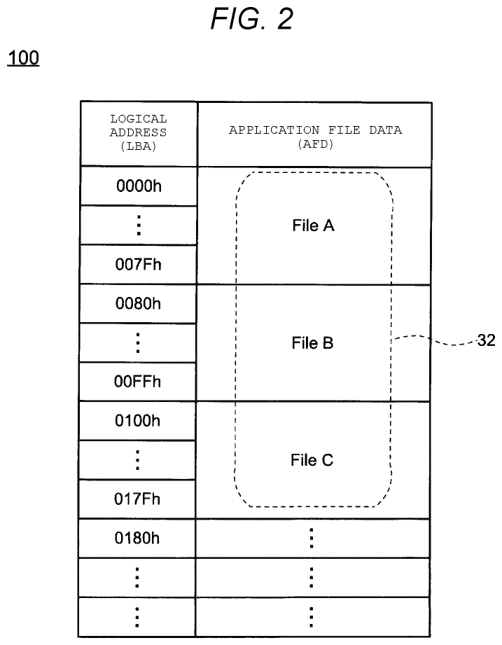

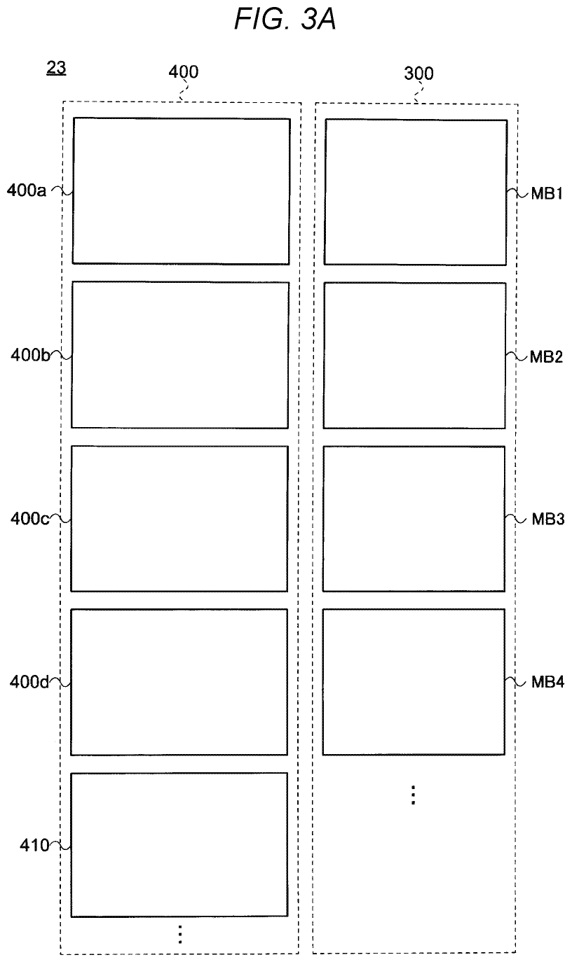

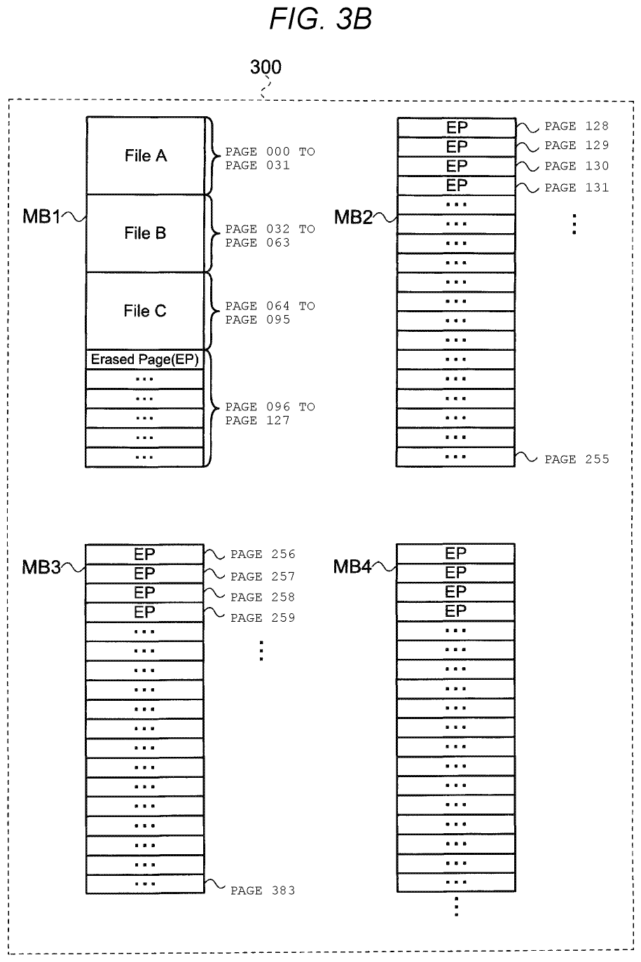

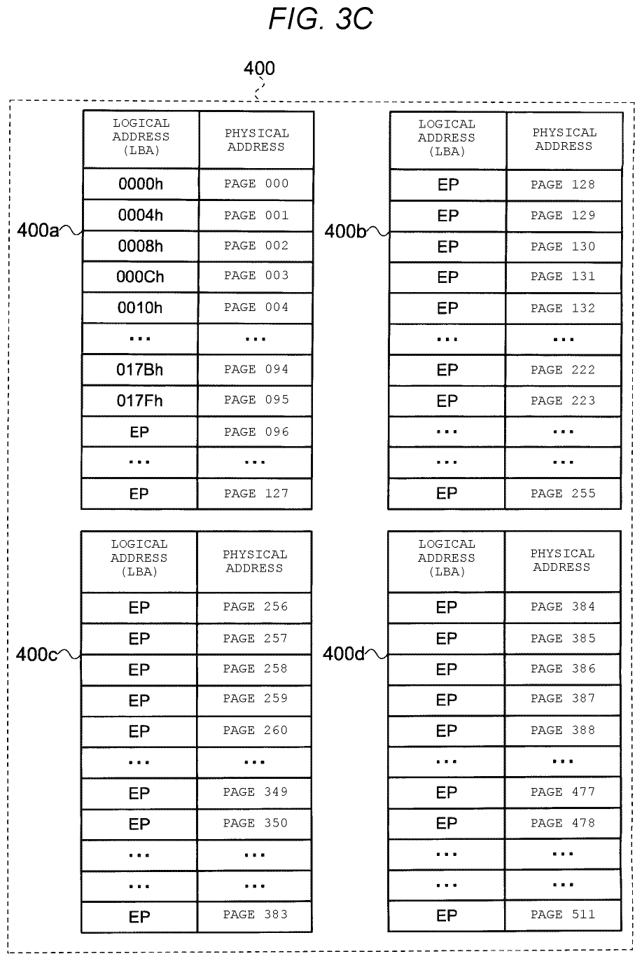

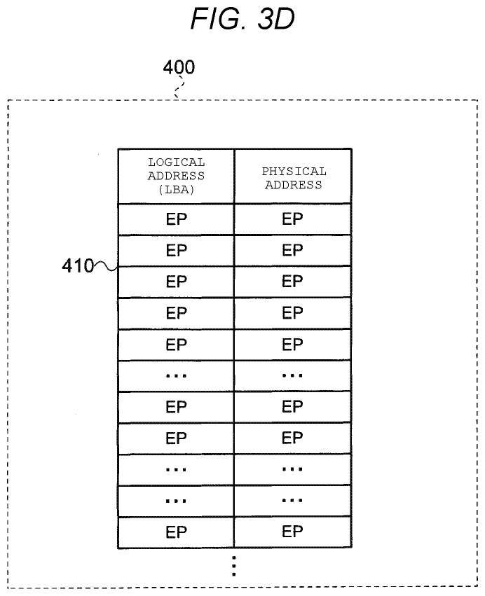

The overall configuration of the memory system 1 will be described with reference to FIGS. 1 to 3C. FIG. 1 is a block diagram showing a configuration of the memory system 1. FIG. 2 is a diagram showing a structure of data generated by an application 32 installed in a host 30. In other words, FIG. 2 is a diagram showing files configuring the application 32 installed in the host 30. FIG. 3A is a diagram showing a configuration of an actual data unit 300 and a table unit 400 in a memory unit 23, FIG. 3B is a diagram n showing the configuration of the actual data unit 300, and FIG. 3C is a diagram showing the configuration of the table unit 400.

The non-volatile memory 20 of the memory system 1 includes a plurality of memory cells. The memory system 1 is connectable to the host 30. The memory system 1 in FIG. 1 is connected to the host 30.

For example, the memory system 1 may be a memory card such as an SD™ card in which the memory controller 10 and the non-volatile memory 20 are configured as one package, a universal flash storage (UFS), or a solid state drive (SSD).

For example, the host 30 is an electronic device such as a personal computer, a mobile terminal, or the like. The host 30 includes a processor and a memory, for example. The processor is configured to execute various programs that are loaded into the memory. The various programs include an operating system (OS), a file system and the application 32 installed in the OS, and the like, for example. The data generated by the application 32 includes application file data (AFD) 321. The AFD 321 includes a plurality of pieces of file data. The OS of the host 30 manages generation, storage, update, deletion, and the like of the AFD, for example. The application 32 is configured to exchange data (actual data) with the memory system 1 via the OS, for example. The data (actual data) is stored as file data.

### <1-2. Configuration of Non-Volatile Memory 20>

The non-volatile memory 20 is a non-volatile memory that stores data in a non-volatile manner. The non-volatile memory 20 is a NAND flash memory (hereinafter simply referred to as NAND memory), for example. Although it is illustrated that a NAND memory is used as the non-volatile memory 20 in the memory system 1, a non-volatile memory other than the NAND memory, such as a three-dimensional structure flash memory, a resistance random access memory (ReRAM), a ferroelectric random access memory (FeRAM), and on the like may be used as the non-volatile memory 20. Various storage media may be applied to the memory system 1.

The non-volatile memory 20 stores data (actual data) transmitted from the host 30, management information of the memory system 1, firmware, and the like. For example, data is the AFD 321. Although details will be described below, the management information includes an application ID, a time stamp, and a logical address, a physical address, a page number, and the like included in the logical-to-physical address conversion table. The management information may include time stamp, time, cumulative read amount, and cumulative write amount, which will be described below. The firmware operates a processor 11 that controls at least a part of the functions of the memory controller 10. A part of the firmware may be stored in a ROM 10.

The non-volatile memory 20 includes a plurality of memory chips 21. The memory controller 10 controls each of the plurality of memory chips 21. Specifically, the memory controller 10 performs a write operation, a read operation, and an erase operation of data on each of the memory chips 21. Each of the plurality of memory chips 21 is connected to the memory controller 10 via a NAND bus.

Each of the memory chips 21 includes a plurality of dies 22. A die 22 is a wafer unit on which the memory cells are formed. The memory chip 21 is configured with stacking the plurality of dies 22.

Each die 22 is provided with a plurality of memory units 23. The memory unit 23 includes a plurality of pages. The memory unit 23 includes the actual data unit 300 and the table unit 400 (FIG. 3A).

The actual data unit 300 includes a plurality of memory blocks MBx (MB1, MB2, MB3, MB4, . . . ) (FIGS. 3A, 3B). The plurality of memory blocks MB include the AFD 321, the firmware, and the like. The memory block MB is a data erase unit. All memory cell transistors provided in the memory block MB are connected to the same source line. One unit of memory block MB may sometimes be referred to as a “physical block”.

In the NAND memory, write operations and read operations are generally performed in data units called “pages”, and erasing is performed in data units of the physical blocks mentioned above. In the memory system 1, a memory cell transistor as the minimum unit of the memory device is simply referred to as a “memory cell”, and the position of the memory cell in the physical block may sometimes be referred to as a “physical address”. In the memory system 1, the “page” means the minimum unit in the write operation. A plurality of memory cells connected to the same word line is referred to as a “memory cell group”. When the memory cells are single level cells (SLCs), one page is configured with one memory cell group. In the case of a multi-bit cell such as a multi-level cell (MLC) in which two pages are configured with one memory cell group, a triple level cell (TLC) in which three pages are configured with one memory cell group, or a quad level cell (QLC) in which four pages are configured with one memory cell group, one memory cell group corresponds to a plurality of pages. Each memory cell is connected to both the word line and the bit line. Therefore, each memory cell can be identified using an address that identifies the word line and an address that identifies the bit line.

The table unit 400 includes a plurality of logical-to-physical address conversion tables. In the logical-to-physical address conversion table, the logical address of data received from the host 30 is mapped to the physical address indicating the page of the actual data unit 300 on the non-volatile memory 20 in which the data is stored. The logical-to-physical address conversion table is commonly referred to as an L2P table. The management information includes logical addresses, physical addresses, page numbers, and the like.

### <1-3. Configuration of Memory Controller 10>

The memory controller 10 is a semiconductor integrated circuit configured as a system on a chip (SoC), for example.

The memory controller 10 controls a write operation of writing to the non-volatile memory 20 according to a write request from the host 30, controls a read operation of reading from the non-volatile memory 20 according to a read request from the host 30, and controls an erase operation of erasing the non-volatile memory 20 according to an erase request from the host 30. The memory controller 10 includes functional blocks such as a host interface (host I/F) 17, a RAM 12, a ROM 13, the processor 11, an ECC 15, and a memory I/F 18. The functional blocks are connected to each other through an internal bus 19.

The host I/F 17 receives a write request, a read request, or an erase request from the host 30, and executes a process according to interface standard between the host 30 and the host I/F 17. The host I/F 17 transmits data read from the non-volatile memory 20 to the host 30, and transmits a response from the processor 11 and the like to the host 30. The write request includes a write command WCMD, a write address, and write data (for example, AFD 321), for example. The read request includes a read command RCMD and a read address, for example. The erase request includes an erase command ERCMD and an erase address, for example.

The interface standard may be a small computer system interface (SCSI) or a serial SCSI (SAS) interface, for example. The interface standard may be a high-speed communication standard such as a universal serial bus (USB), an advanced technology attachment (ATA), or serial ATA.

The RAM 12 is used as a data buffer, for example, and temporarily stores the data received by the memory controller 10 from the host 30 until the data is stored in the non-volatile memory 20. The RAM 12 temporarily stores the data read from the non-volatile memory 20 until the data is transmitted to the host 30. The L2P table and the like read out from the non-volatile memory 20 based on each command is loaded to the RAM 12. For example, a general-purpose memory such as a static random access memory (SRAM) or a dynamic random access memory (DRAM) may be used as the RAM 12.

The ROM 13 stores various programs, parameters, and the like for operating the memory controller 10. The programs, parameters, and the like stored in the ROM 13 are read out and executed by the processor 11 as needed.

The processor 11 is a control unit that comprehensively controls each functional block of the memory system 1. The processor 11 includes a data management unit 110 and a write/read (W/R) management unit 111. The functions of the data management unit 110 may be implemented by hardware, or may be implemented by a CPU executing a firmware. The functions of the W/R management unit 111 may be implemented by hardware, or may be implemented by a CPU that executes a firmware.

When the processor 11 receives a request from the host 30 via the host I/F 17, the processor 11 uses the data management unit 110 and the W/R management unit 111 to perform control according to the request.

The memory I/F 18 executes the write operation, the read operation, and the erase operation with respect to the non-volatile memory 20 based on instructions from the processor 11. Based on the instructions from the processor 11, the memory I/F 18 may perform other operations such as an operation based on a first command, for example.

For example, in response to a write request from the host 30, the processor 11 instructs the memory I/F 18 to write data to the non-volatile memory 20. For example, in response to a write request from the host 30, the data management unit 110 uses the L2P table included in the table unit 400 to determine a write destination (physical address indicating a page in the actual data unit 300) on the non-volatile memory 20 for the data to be written temporarily stored in the RAM 12. That is, the data management unit 110 manages data to be written and a write destination of data. The W/R management unit 111 receives the physical address from the data management unit 110 and instructs the memory I/F 18 to perform the write operation to write the data to be written to the physical address. The memory I/F 18 outputs the data to be written and the physical address to the non-volatile memory 20, and the data to be written is stored in the page of the actual data unit 300 corresponding to the physical address. The correspondence between the logical address of the data to be written received from the host 30 and the physical address at which the data to be written is stored is stored in the L2P table included in the table unit 400.

In response to a read request from the host 30, the processor 11 instructs the memory I/F 18 to read data from the non-volatile memory 20. For example, in response to a read request from the host 30, the data management unit 110 uses the L2P table included in the table unit 400 to determine a physical address indicating a page in the actual data unit 300 on the non-volatile memory 20, which corresponds to a logical address of data to be read. That is, the data management unit 110 uses the L2P table to manage the logical address of the data to be read and the physical address corresponding to the logical address. The W/R management unit 111 receives the physical address from the data management unit 110, and instructs the memory I/F 18 to perform the read operation to read the data to be read from the physical address. The memory I/F 18 outputs the data to be read and the physical address to the non-volatile memory 20, and reads the data to be read from the physical address.

In response to an erase request from the host 30, the processor 11 instructs the memory I/F 18 to erase data in the non-volatile memory 20. For example, in response to the erase request from the host 30, the data management unit 110 uses the L2P table included in the table unit 400 to determine a physical address indicating a page in the actual data unit 300 on the non-volatile memory 20, which corresponds to a logical address of data to be erased. That is, the data management unit 110 manages the logical address of the data to be erased and the physical address corresponding to the logical address. The W/R management unit 111 receives the physical address from the data management unit 110 and instructs the memory I/F 18 to perform an erase operation to erase the data to be erased from the physical address. The memory I/F 18 outputs the data to be erased and the physical address to the non-volatile memory 20, and erases the data to be erased from the physical address.

The data management unit 110 executes garbage collection (GC) (also referred to as “compaction”) and application-based optimization (ABO) processes. For example, the data management unit 110 counts the number of free blocks (FBs), which will be described below, and when the number of FBs is less than or equal to a predetermined threshold, the data management unit 110 executes GC. When the number of FBs is greater than the predetermined threshold, the data management unit 110 does not need to perform the GC process.

The garbage collection (GC, also referred to as “compaction”) is a process to increase the number of usable physical blocks, and refers to, for example, a process of collecting valid data from a plurality of active blocks including valid data and invalid data, rewriting the valid data into another block, and allocating a free block. The active block indicates a physical block in which valid data is recorded. The free block indicates a physical block in which no valid data is recorded. After erasure, free blocks can be reused as erased blocks. The free blocks include both blocks before erasure in which no valid data is recorded and erased blocks. The valid data is the data mapped to the logical address which will be described below, and the invalid data is the data not mapped to the logical address. The erased block becomes an active block when data is written. The invalid data is indicated by diagonal lines in the drawing.

Application-based optimization (ABO) refers to a process of storing each of a plurality of pieces of application data corresponding to continuous logical addresses generated using the same application in the physical blocks corresponding to continuous physical addresses in the non-volatile memory 20 in the order of the corresponding logical addresses.

The ECC 15 executes ECC encoding (error correction encoding) during the write operation and ECC decoding (error correction decoding) during the read operation based on the instructions from the processor 11. For the encoding method of the ECC 15, for example, an encoding method using a low-density parity-check (LDPC) code, a Bose-Chaudhuri-Hocquenghem (BCH) code, or a Reed-Solomon (RS) code may be adopted.

In the memory system 1 with the configuration described above, when executing the write operation with respect to the non-volatile memory 20, the processor 11 determines a write destination of the data to be written in the non-volatile memory 20 (physical address indicating the page in the actual data unit 300), and instructs the memory I/F 18 of a physical address indicating the determined page in the actual data unit 300. For example, the ECC 15 performs the ECC encoding on the data to be written based on the instructions from the processor 11. The data to be written generated as such is written to the specified page of the non-volatile memory 20 via the memory I/F 18.

Meanwhile, in the read operation with respect to the non-volatile memory 20, the processor 11 specifies a physical address on the non-volatile memory 20, determines conditions for the read operation of the memory cell according to the specified physical address, and instructs the memory I/F 18 to execute the read operation. The processor 11 instructs the ECC 15 to start ECC decoding. The memory I/F 18 executes the read operation for the specified physical address of the non-volatile memory 20 according to the instructions from the processor 11, and inputs the read data obtained by the read operation to the ECC 15. The ECC 15 decodes the input read data. When the decoding is successful, the processor 11 stores the read data in the RAM 12. Meanwhile, when the ECC decoding fails, the processor 11 notifies the host 30 of a read error, for example.

### <1-4. Structure of Data Generated by Application 32>

The data structure generated by the application 32 will be described with reference to FIG. 2. The application 32 includes the AFD 321. The data generated by the application 32 is specified by a logical address of the host 30. In a logical address space 100, the AFDs are mapped to the logical addresses.

For example, logical block addressing (LBA) is used as the logical address. The LBA includes 0000h, 0080h, 0100h, 0180h, 0200h, . . . , for example.

The data generated by the application 32 includes a file A (File A), a file B (File B), and a file C (File C), for example. File A, File B, and File Care file data generated using the same application. For example, one file includes 32 pages, and one page includes 4 LBAs. File A is mapped to 0000h to 007Fh, File B is mapped to 0080h to 00FFh, and File C is mapped to 0100h to 017Fh. In the first embodiment, File A to File C are referred to as first to third file data.

### <1-5. Configuration of Actual Data Unit 300 and Table Unit 400>

The configurations of the actual data unit 300 and the table unit 400 will be described with reference to FIGS. 3A to 3D. FIGS. 3A to 3D are diagrams showing the state of the actual data unit 300 or the table unit 400 in which File A to File C of the AFD 321 are stored in the non-volatile memory 20, as the memory system 1 receives the write request and executes the write operation based on the write command WCMD. For example, the actual data unit 300 includes four memory blocks MB1 to MB4 (MBx, x=1 to 4) (FIG. 3A). One memory block includes 128 pages (FIG. 3B). File A is stored in page 000 to page 031 of MB1, File B is stored in page 032 to page 063 of MB1, and File C is stored in page 064 to page 095 of MB1. No data is stored in page 096 to page 127 of MB1, each page of MB2, each page of MB3, and each page of MB4. That is, page 096 to page 127 of MB1, each page of MB2, each page of MB3, and each page of MB4 are pages that have no mapping between the physical addresses and the logical addresses in the actual data unit 300 and the table unit 400, and are erased pages (EPs).

The table unit 400 includes four L2P tables (a first L2P table 400a, a second L2P table 400b, a third L2P table 400c, and a fourth L2P table 400d) (FIGS. 3A and 3C), for example. An application-specific L2P table 410 for the application shown in FIG. 3D may be generated as necessary. The application-specific L2P table 410 is a table that maps the file data generated using the same application with the logical address corresponding to the file data. Applications may sometimes be referred to as groups, and the same applications may sometimes be referred to as the same group.

In the memory system 1, each of the first L2P table 400a, the second L2P table 400b, the third L2P table 400c, and the fourth L2P table 400d map each of the physical addresses for 128 pages with the logical addresses corresponding to each of the physical addresses for the 128 pages. Specifically, in the first L2P table 400a of the memory system 1, page 000 to page 127 of the physical addresses are mapped to the logical addresses corresponding to each of the physical addresses. Like the first L2P table 400a, in the second L2P table 400b, page 128 to page 255 of the physical addresses are mapped to the logical addresses corresponding to each of the physical addresses, in the third L2P table 400c, page 256 to page 383 of the physical addresses are mapped to the logical addresses corresponding to each of the physical addresses, and in the fourth L2P table 400d, physical addresses of the page 384 to page 511 of the physical addresses are mapped to the logical addresses corresponding to each of the physical addresses. More specifically, in the first L2P table 400a, the page 000 to page 095 of the physical addresses are mapped to 0000h to 017Fh of the logical addresses. The physical addresses of the page 096 to page 127 of the physical addresses of the first L2P table 400a, each page of the physical addresses of the second L2P table 400b, each page of the physical addresses of the third L2P table 400c, each page of the physical addresses of the fourth L2P table 400d, and each page of the physical addresses of the application-specific L2P table 410 are pages that have no mapping with the logical addresses, and are erased pages (EPs). In the first embodiment, there may be no mapping that the LBA of the first L2P table 400a, the second L2P table 400b, the third L2P table 400c, and the fourth L2P table 400d is EP.

The memory system 1 can store File A, File B, and File C, which are generated using the same application 32 and which correspond to continuous logical addresses 0000h to 017Fh in the pages corresponding to continuous physical addresses of the non-volatile memory 20 in the order of the logical addresses 0000h to 017Fh.

### <1-6. First Example of Operating Method of Memory System 1 (First Example)>

A first example of an operating method of the memory system 1 will be described with reference to FIGS. 2 to 7C. The operating method of the first example includes updating file data generated using the application 32 in the host 30, receiving, by the memory system 1, a write request from the host 30 based on the updated file data, executing, by the memory controller 10, a write operation based on the write request, and executing, by the data management unit 110, an ABO process. The operating method of the first example may include, after performing the write operation, performing GC by the data management unit 110, or after performing GC, performing the ABO process by the data management unit 110.

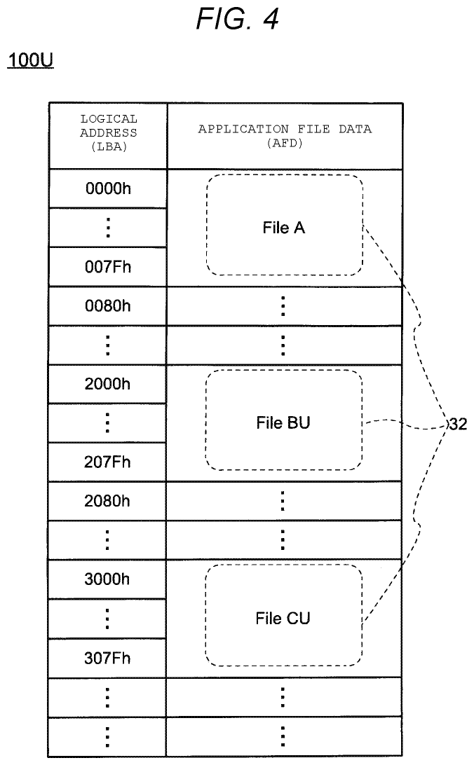

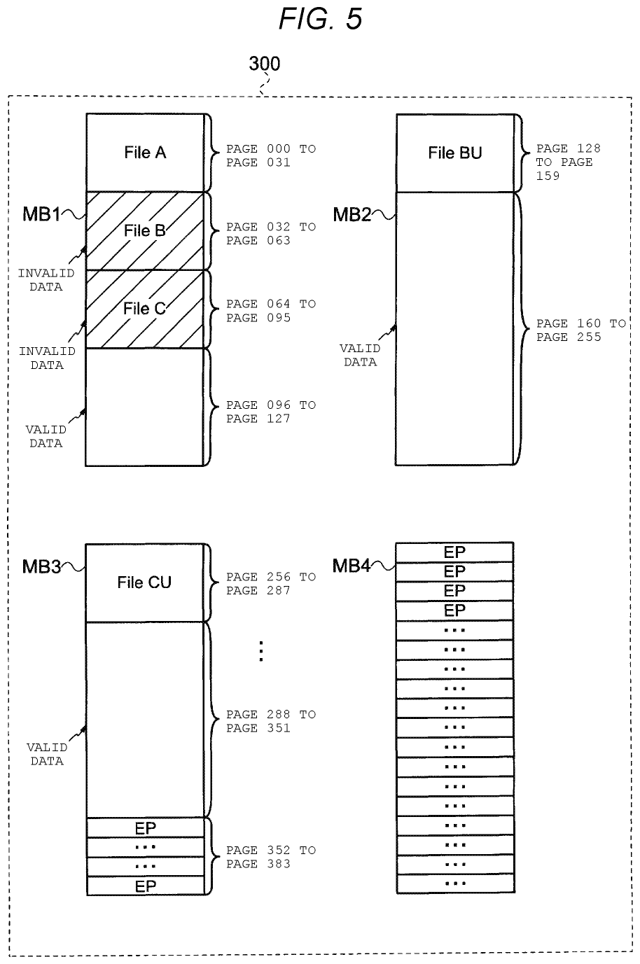

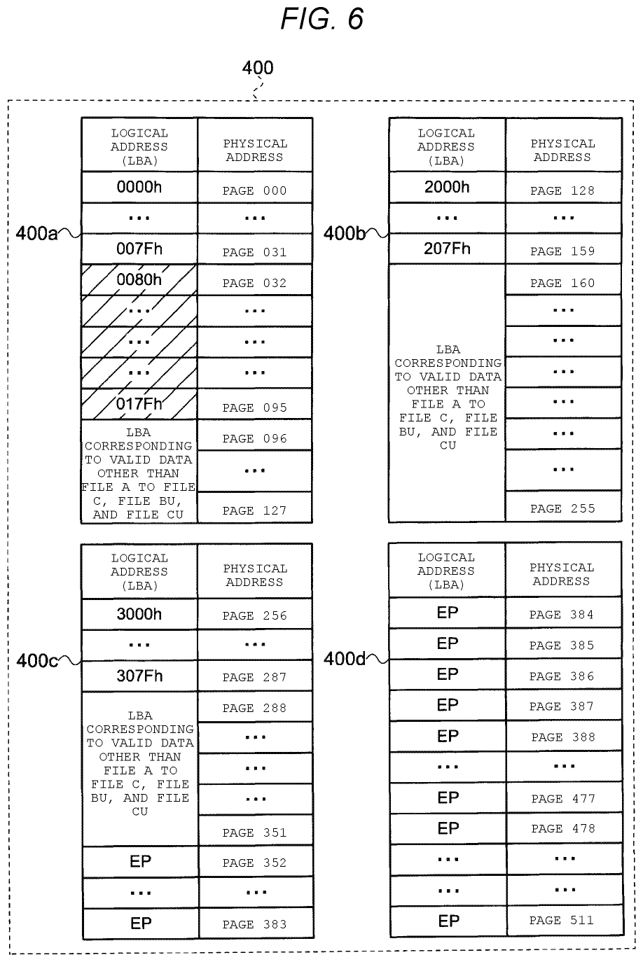

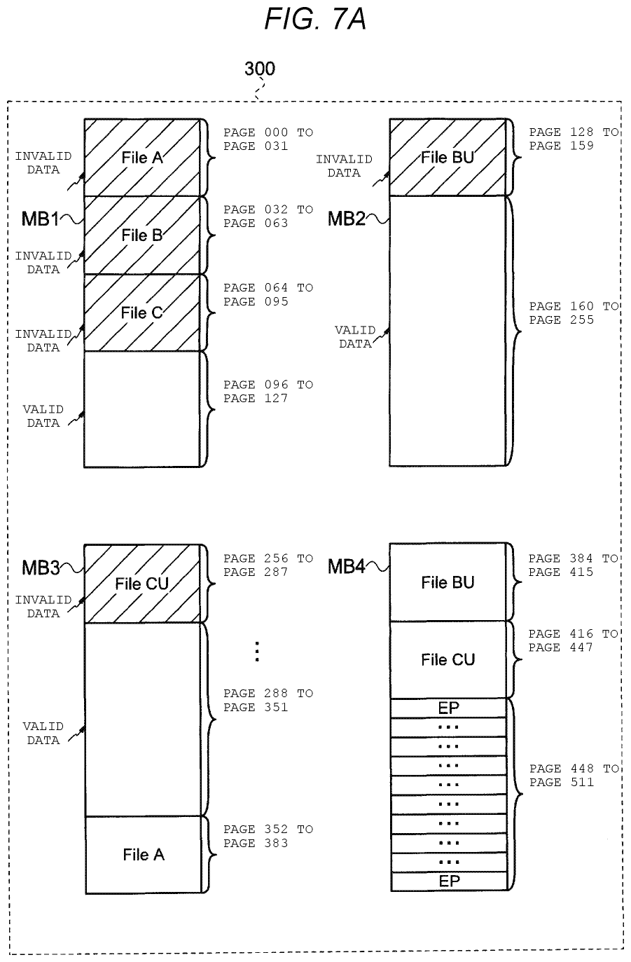

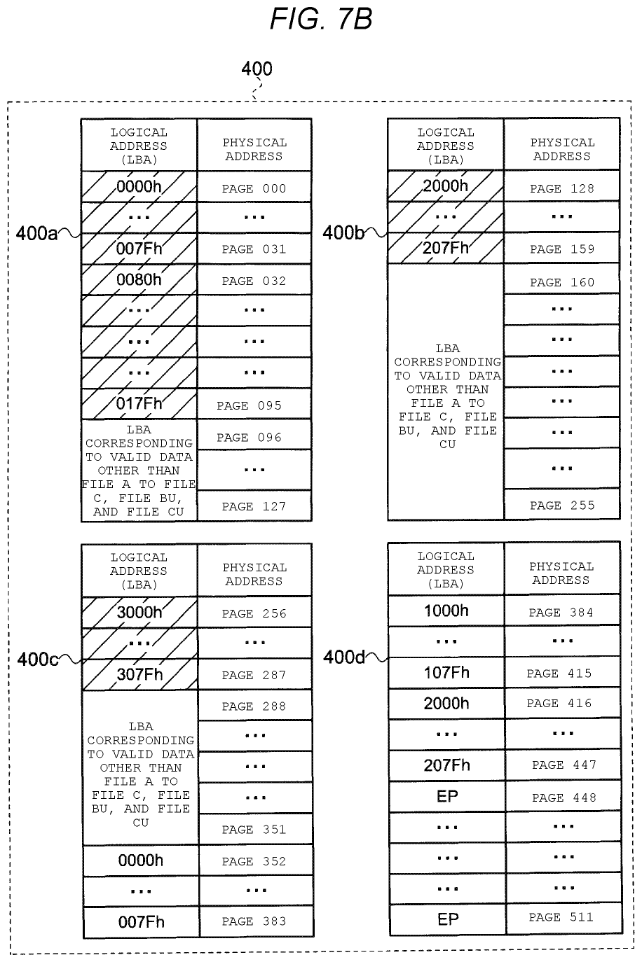

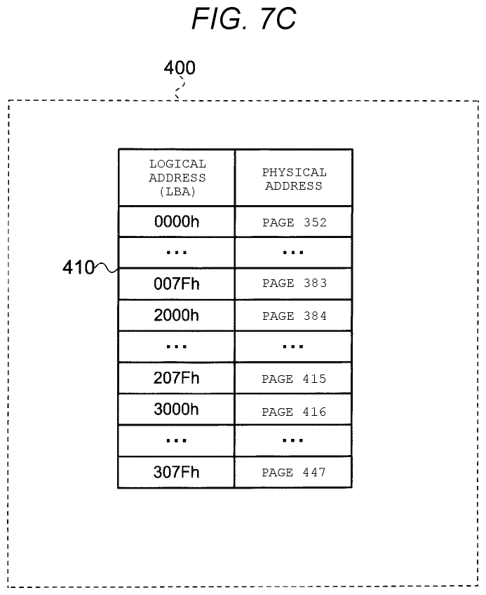

FIG. 4 is a diagram showing a structure of updated data when the data generated by the application 32 is updated. FIG. 5 is a diagram showing a configuration of the actual data unit 300 after updating. FIG. 6 is a diagram showing a configuration of the table unit 400 after updating. FIGS. 7A to 7C are diagrams showing a configuration of the actual data unit 300 or the table unit 400 after the ABO process. In describing the operating method of the first example of the memory system 1, description of the configurations that are the same as or similar to those in FIGS. 1 to 3D may be omitted.

The structure of the updated data, when data generated by the application 32 is updated, will be described with reference to FIG. 4. File B and File C are updated to file BU (File BU) and file CU (File CU). File A is mapped to 0000h to 007Fh as before the update. File BU is mapped to 2000h to 207Fh, and File CU is mapped to 3000h to 307Fh.

The configurations of the updated actual data unit 300 and the table unit 400 will be described with reference to FIGS. 5 and 6. When the memory controller 10 receives a write request including a write command WCMD and write data from the host 30, the memory controller 10 executes the write operation described in “1-3. Configuration of Memory Controller 10” based on the write command WCMD and the write data.

FIG. 5 is a diagram schematically showing a data arrangement in the actual data unit 300 after the process described below is executed, for example.

After generating File A, File B, and File C, the host 30 generates other data and transmits the same to the memory system 1. The memory system 1 stores the other data in page 096 to page 127 of the memory block MB1.

Then, the host 30 updates File B to File BU and transmits the result to the memory system 1. The memory system 1 stores File BU in page 128 to page 159 of the memory block MB2. The host 30 generates other data different from the data stored in page 096 to page 127 and transmits the result to the memory system 1. The memory system 1 stores the other data received from the host 30 in page 160 to page 255 of the memory block MB2.

Then, the host 30 updates File C to File CU and transmits the result to the memory system 1. The memory system 1 stores File CU in page 256 to page 287 of the memory block MB3. The host 30 generates other data different from the data stored in page 096 to page 127 and page 160 to page 255, and transmits the result to the memory system 1. The memory system 1 stores the other data received from the host 30 in page 287 to page 351 of the memory block MB3. File B stored in page 032 to page 063 and File C stored in page 064 to page 095 become invalid data that is not mapped to the logical address.

For example, in the first L2P table 400a of the updated table unit 400 shown in FIG. 6, same as before the update, File A (page 000 to page 031 of the physical addresses) is mapped to 0000h to 007Fh of the logical addresses, and File A stored in the mapping of File B and File C, which were stored in page 032 to page 095 of the physical addresses that corresponded to the logical addresses 0080h to 017Fh, no longer exists (described as invalid data in FIG. 6), and file data in page 096 to page 127 of the physical addresses mapped to LBAs corresponding to valid data other than File A to File C, File BU, and File CU are valid data. In the second L2P table 400b, File BU (page 128 to page 159 of physical address) is mapped to logical addresses 2000h to 207Fh, and File BU stored in page 128 to page 159 is valid data. File data in page 160 to page 255 of the physical addresses mapped to logical addresses corresponding to valid data other than File A to File C, File BU, and File CU are valid data. In the third L2P table 400c, File CU (page 256 to page 287 of the physical address) is mapped to 3000h to 307Fh of the logical addresses, and File CU stored in page 256 to page 287 is valid data. File data in page 288 to page 351 of the physical addresses mapped to logical addresses corresponding to valid data other than File A to File C, File BU, and File CU are valid data. The physical address of page 352 to page 383 in the third L2P table 400c and the physical address of each page in the fourth L2P table 400d are pages that have no mapping with the logical address, and are erased pages (EPS). The application-specific L2P table 410 is in the same state as in FIG. 3D even after the update. In the first embodiment, the mapping of the LBA (shaded area) of invalid data may not exist.

The configurations of the actual data unit 300 and the table unit 400 after the memory controller 10 executes the ABO process will be described with reference to FIGS. 7A to 7C. In describing the configuration of the actual data unit 300 and the table unit 400 after executing the ABO process with reference to FIGS. 7A to 7C, the description will focus on the differences from the configurations of the actual data unit 300 and the table unit 400 illustrated with reference to FIGS. 5, 6, and 3D.

The memory controller 10 executes the ABO process after executing the write operation of update data and the like. For example, in the actual data unit 300 shown in FIG. 7A, File A is stored in page 352 to page 383 of the memory block MB3, File BU is stored in page 384 to page 415 of the memory block MB3, and File CU is stored in page 416 to page 447 of the memory block MB3. File A stored in page 000 to page 031, File BU stored in page 128 to page 159, and File CU stored in page 256 to page 287 are invalid data that are not mapped to the logical addresses.

In the third L2P table 400c of the table unit 400 shown in FIG. 7B, page 352 to page 383 of the physical addresses are mapped to 0000h to 007Fh of the logical addresses. In the fourth L2P table 400d, page 384 to page 415 of the physical addresses are mapped to 1000h to 107Fh of the logical addresses, and page 416 to page 447 of the physical addresses are mapped to 2000h to 207Fh of the logical addresses. File A stored in page 000 to page 031 of the physical addresses corresponding to 0000h to 007Fh of the logical addresses of the first L2P table 400a, File BU stored in page 128 to page 159 of the physical addresses corresponding to 2000h to 207Fh of the logical addresses of the second L2P table 400b, and File CU stored in page 256 to page 287 of the physical addresses corresponding to 3000h to 307Fh of the logical addresses of the third L2P table 400c are invalid data.

That is, the memory controller 10 executes the ABO process, and the non-volatile memory 20 stores the file data (File A to File C) generated using the same application 32 in page 352 to page 447 of continuous physical addresses in the actual data unit 300. After executing the ABO process, the non-volatile memory 20 maps page 352 to page 447 of the physical addresses in which File A is stored within 0000h to 007Fh of the logical addresses, page 384 to page 415 of the physical addresses in which File B is stored within 2000h to 207Fh of the logical addresses, page 416 to page 447 of the physical addresses in which File C is stored within 3000h to 307Fh of the logical addresses, respectively, in which the files are generated using the same application 32, and stores the mapping in the application-specific L2P table 410 (See FIG. 7C).

The first example of the operating method of the memory system 1 is capable of executing the ABO process of storing a plurality of pieces of application data included in the AFD 321 in physical blocks corresponding to continuous physical addresses mapped in the order of LBA. Therefore, when the host 30 starts the application 32, it is possible to read a plurality of pieces of application data from the memory system 1 in the order of LBA.

The memory system 1 may execute GC, collect the valid data from a plurality of active blocks as well as the file data obtained by subdividing AFD stored in a plurality of pages, and rewrite the result into another block to allocate a free block. After performing the operation of storing the file data obtained by subdividing the AFD into SLC in the non-volatile memory 20, the memory system 1 may then perform an operation of storing the file data obtained by subdividing the AFD into TLC again in the non-volatile memory 20. When the memory system does not have the ABO process implemented in the memory controller 10 of the memory system 1 and starts the application using the file data obtained by subdividing the AFD, it is necessary to read the file data subdivided and stored in the non-volatile memory from the non-volatile memory. Therefore, in the memory system that does not have the ABO process implemented in the memory controller 10 of the memory system 1, it takes more time to read the subdivided and stored file data than in the memory system 1. That is, it may take time for the host connected to the memory system that does not have the ABO process, which is implemented in the memory controller 10 of the memory system 1, to start an application file.

Meanwhile, in the case described above, when the host 30 starts the application 32, the memory system 1 can read the AFD 32 (File A, File BU, and File CU) corresponding to LBA 0000h to 007Fh, LBA 2000h to 207Fh, and 3000h to 307Fh from the non-volatile memory 20 in the memory system 1 from page 352 to page 447 corresponding to continuous physical addresses. Therefore, the memory system 1 can shorten the time required to read the file data when starting the application 32, compared to a memory system implemented in the memory controller 10 of the memory system 1 which does not have ABO process. That is, the memory system 1 can speed up the read operation of file data when starting the application 32.

For example, when the number of FBs is greater than a predetermined threshold, the data management unit 110 may execute the ABO process after writing the file data or writing the updated file data based on the write command WCMD without executing the GC process.

### <1-7. Second Example of Operating Method of Memory System 1 (Second Example)>

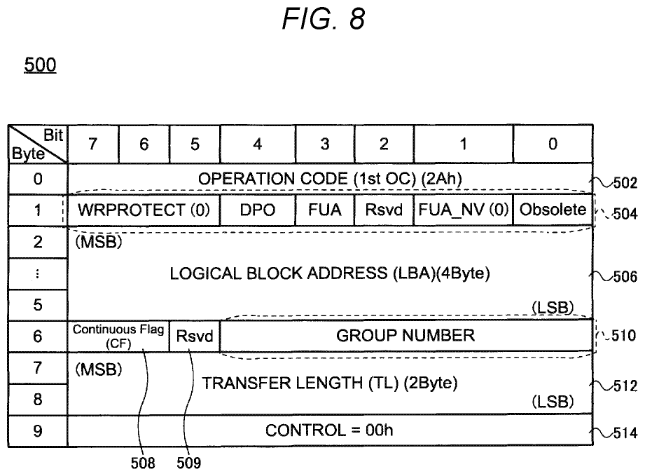

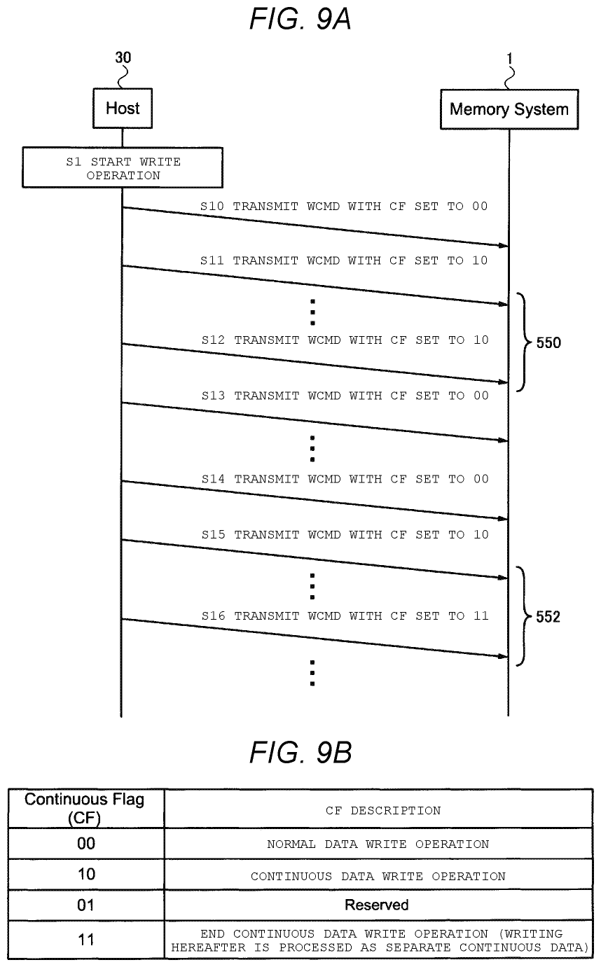

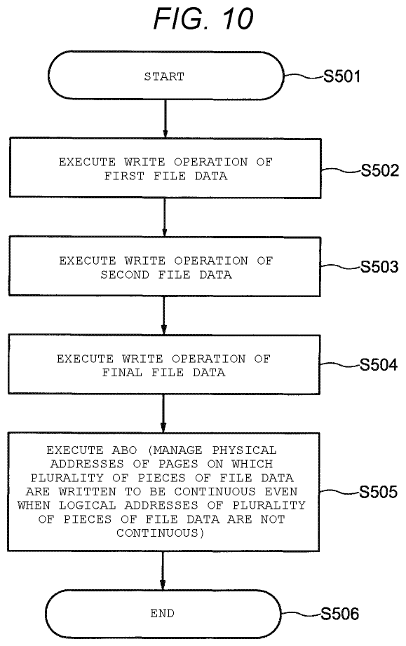

A second example of the operating method of the memory system 1 will be described with reference to FIGS. 8 to 10. FIG. 8 is a diagram showing an example of a format 500 of the write command WCMD. FIG. 9A is a diagram showing an example of an operation sequence of the memory system 1. FIG. 9B is a diagram showing an example of the settings of the write command WCMD shown in FIG. 8. FIG. 10 is a flowchart showing a second example of the operating method of the memory system 1. In describing the operating method of the second example of the memory system 1, description of the configurations that are the same as or similar to those in FIGS. 1 to 7C may be omitted.

The format 500 of the write command WCMD will be described with reference to FIGS. 8 and 9B. For example, the format 500 may be an SCSI compliant format. When transmitting a request to write file data from the host 30 to the memory system 1, the format 500 specifies an LBA start address corresponding to the file data and a size of the file data, for example.

The format 500 includes an operation code (OC) 502, a plurality of individual setting codes 504, an LBA 506, a continuous flag (CF) 508, a reserved area (Rsvd) 509, a group number 510, a transfer length (TL) 512, and a control byte 514. The codes, data, values, and the like set in the format 500 are referred to as setting information.

The OC 502 indicates that the request being transmitted (for example, command, descriptor block) is a write request and includes a first operation code (1st OC). The block size of the OC 502 is 1 byte, for example, and the OC 502 includes a predetermined value of 2 Ah. A plurality of individual setting codes 504 include codes that can be individually set such as WRPROTECT(0), DPO, FUA, and FUN_NV(0), as well as Rsvd that is an extension block. Obsolete is a code that was used in the past, but is now forbidden.

The LBA 506 is an LBA start address. The size of the LBA 506 is 4 bytes, for example. The size of the LBA 506 is not limited to 4 bytes, and may be selected as appropriate based on the purpose, specifications, and the like of the memory system 1. For example, when the format 500 is a request to write 1 MByte of file data to a start address of 0x0100 (0x00000100), the LBA 506 is set to 0x0100.

The CF 508 includes CF data, the size of the CF data is 2 bits, for example, and the CF 508 is set as shown in FIG. 9B, for example. When 0b00 (CF=00) is set as the CF data, the format 500 represents a write request instructing a write operation of normal data. The normal data write operation is an operation in which a plurality of pieces of data are not written to pages corresponding to continuous physical addresses, for example. When 0b10 (CF=10) is set in the CF data, the format 500 represents a write request instructing continuous data write operation and ABO process. The continuous data write operation and ABO process are operations that write data to pages corresponding to continuous physical addresses. When CF is set to 0b11 (CF=11), the format 500 represents a write request instructing an end of the write operation of continuous data with CF=10. The write data transmitted to the memory system 1 together with the format 500 in which CF is set to 0b11 (CF=11) is the last data of the continuous data. The memory system 1 processes the write command WCMD after the write command WCMD in which CF=11 is set as a write request different from the write command WCMD in which CF=10 to CF=11 are set.

The format 500 is continuously described with reference to FIG. 8. The transfer length (TL) 512 indicates the size of file data. The size of TL 512 is 2 bytes, for example. The size of the TL 512 is not limited to 2 bytes, and may be selected as appropriate based on the purpose, specifications, and the like of the memory system 1.

The Rsvd 509 is an extension block, and the group number 510 and the control byte 514 are codes that can be individually set, and detailed description thereof will be omitted here.

An example of the operation sequence of the memory system 1 will be described with reference to FIG. 9A. An example of the operation sequence shown in FIG. 9A includes transmitting a write request from the host 30 to the memory system 1 multiple times continuously to write a plurality of pieces of AFDs (for example, File A to File C) included in the data generated by the same application 32. Each write request includes a write command WCMD that includes the format 500 shown in FIG. 8. The format 500 includes 1st OC corresponding to a write request, and CF data that can set continuous data writing and ABO process.

First, the host 30 starts a write operation (step S1). The host 30 transmits a first write command WCMD including the format 500 in which OC, CF, LBA, and TL are set to a first operation command (1st OC), “0b00”, a predetermined address, and a predetermined size to the memory system 1 (step S10).

Next, the host 30 transmits the second write command WCMD including the format 500 in which the CF, LBA, and TL set in step S10 are changed to “0b10”, a predetermined address, and a predetermined size to the memory system 1 without changing the OC set in step S10 (step S11).

Next, in a plurality of steps from step S11 to step S12, the host 30 transmits, to the memory system 1, a write command WCMD including the format 500 with the CF set to 0b10 as in step S11.

Since the CF of the format 500 is set to 0b10 in the plurality of steps from step S11 to step S12, the memory controller 10 in the memory system 1 instructs the non-volatile memory 20 to store the application file data received from the host 30 in steps S11 and S12 in the pages corresponding to continuous physical addresses based on the write command WCMD received from the host 30 from step S11 to step S12. The operations of the host 30 and the memory system 1 in steps S11 and S12 correspond to the operations during a period 550.

Next, in a plurality of steps from step S13 to step S14 following step S12, the host 30 transmits, to the memory system 1, a write command WCMD including the format 500 in which the OC, CF, LBA, and TL are set to 1st OC, “0b00”, a predetermined address, and a predetermined size.

Since the CF of the format 500 is set to 0b00 in a plurality of steps from step S13 to step S14, the memory controller 10 in the memory system 1 instructs the non-volatile memory 20 to write the application file data received from the host 30 in steps S13 to S14 to a page corresponding to a predetermined physical address based on the write command WCMD received from the host 30 from step S13 to step S14.

Next, in a plurality of steps after step S15, the host 30 transmits, to the memory system 1, a write command WCMD including the format 500 in which the OC, CF, LBA, and TL are set to 1st OC, “0b10”, a predetermined address, and a predetermined size as in step S12. In step S16, the host 30 transmits, to the memory system 1, a third write command WCMD including the format 500 in which the OC, CF, LBA, and TL are set to 1st OC, “0b11”, a predetermined address, and a predetermined size.

Since the CF of the format 500 is set to 0b11 in step S16, the memory controller 10 in the memory system 1 instructs the non-volatile memory 20 to store the application file data received from the host 30 in steps s S15 to S16 to a page corresponding to a predetermined physical address based on the write command WCMD received from the host 30 from step S15 to step S16. The operations of the host 30 and the memory system 1 in steps S15 and S16 correspond to the operations during a period 552. The memory controller 10 in the memory system 1 instructs the non-volatile memory 20 to store the application file data received in the operations during the period 550 and the operations during the period 552 as data corresponding to a continuous series of write operations in the pages corresponding to continuous physical addresses.

A second example of the operating method of the memory system 1 will be described with reference to FIG. 10. The second example of the operating method of the memory system 1 shown in FIG. 10 is an example in which two pieces of application file data are stored in the pages corresponding to continuous physical addresses in the example of the operation sequence shown in FIG. 9A. In describing the second example of the operating method of the memory system 1, descriptions similar to the example of the operation sequence shown in FIG. 9A will be omitted.

Step S501 corresponds to step S1. Next, the memory controller 10 receives the first write command WCMD including the format 500 from the host 30 and File A of the AFD 321 included in the application 32, and uses the W/R management unit 111 and the data management unit 110 to store File A in the non-volatile memory 20 based on the first write command WCMD (step S502). In the format 500 included in the first write command WCMD, the OC, CF, LBA, and TL are set to 1st OC, “0b00”, 0000h which is the LBA of File A, and 512 Kbytes which is the transfer length of File A. LBA is 4 Kbytes per address, for example.

Next, the memory controller 10 receives the second write command WCMD including the format 500 and File B of the AFD 321 from the host 30, and uses the W/R management unit 111 and the data management unit 110 to store File B in the non-volatile memory 20 based on the second write command WCMD (step S503). In the format 500 included in the second write command WCMD, the OC, CF, LBA, and TL are set to 1st OC, “0b10”, 0080h which is the LBA of File B, and 512 Kbytes which is the transfer length of File B.

Next, the memory controller 10 receives the third write command WCMD including the format 500 and File C of the application file data 321 from the host 30, and uses the W/R management unit 111 and the data management unit 110 to store File C in the non-volatile memory 20 based on the third write command WCMD (step S504). File C is the last file data following File B in the series of data from File A to File C. In the format 500 included in the third write command WCMD, the OC, CF, LBA, and TL are set to 1st OC, “0b11”, 0100h which is the LBA of File C, and 512 Kbytes which is the transfer length of File c.

Next, the data management unit 110 executes the ABO process based on the CF data (11) included in the third write command WCMD (step S505). The data management unit 110 may store File A, File B, and File C in the pages corresponding to continuous physical addresses of the non-volatile memory 20 via the memory I/F in the order of logical addresses 0000h to 017Fh. The data management unit 110 may manage application file data stored in the pages corresponding to continuous physical addresses of the non-volatile memory 20 in the order of logical addresses 0000h to 017Fh.

Here, the data management unit 110 maps the logical addresses 00h to 04h with pages corresponding to continuous physical addresses of the non-volatile memory 20, and stores the logical addresses 00h to 04h and the pages corresponding to continuous physical addresses of the non-volatile memory 20 in at least one L2P table among the plurality of L2P tables included in the table unit 400.

The data management unit 110 executes the ABO process and, when step S505 is completed, the write operation ends (step S506).

The memory system 1 may store a plurality of files corresponding to continuous logical addresses generated using the same application 32 in the pages corresponding to continuous physical addresses of the non-volatile memory 20 in the order of the corresponding logical addresses.

### Second Embodiment

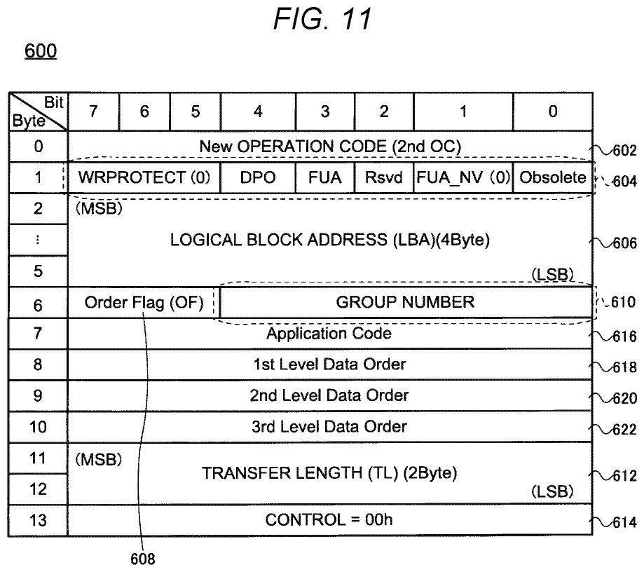

The memory system 1 according to a second embodiment will be described. The operating method of the memory system 1 according to the second embodiment is different from the operating method of the memory system 1 according to the first embodiment. Components of the memory system 1 according to the second embodiment other than the operating method are the same as the configuration of the first embodiment. Hereinafter, differences from the first embodiment will be mainly described with reference to FIGS. 11 to 14.

### <2-1. Format 600>

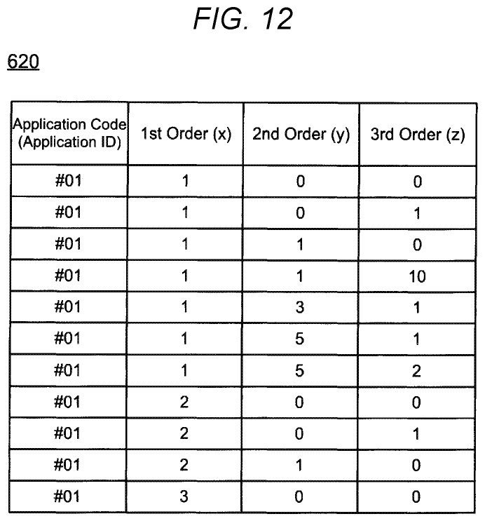

Format 600 of the write command WCMD will be described with reference to FIGS. 11 and 12. FIG. 11 is a diagram showing an example of the format 600 of the write command WCMD of the memory system 1 according to the second embodiment. FIG. 12 is a diagram showing an example of settings for application codes and level orders included in the format 600. The format 600 differs from the format 500 according to the first embodiment in the operation code (OC), order flag (OF), application code, and data order. Like the format 500, the codes, data, the level order, the values, and the like set in the format 600 are referred to as setting information.

The format 600 includes OC 602, OF 608, application code 616, first level data order 618, second level data order 620, and third level data order 622, as well as a plurality of individual setting codes 604, LBA 606, group number 610, transfer length (TL) 612, and control byte 614. The plurality of individual setting codes 604, LBA 606, group number 610, transfer length (TL) 612 and control byte 614 are the same as the plurality of individual setting codes 504, LBA 506, group number 510, transfer length (TL) 512, and control byte 514, and the description thereof will be omitted.

The OC 602 indicates that a block to be transferred (for example, command, descriptor block) is a write request, and includes a second operation code (2nd OC). The block size of the OC 602 is 1 byte, for example.

The OF 608 includes OF data, and the size of the OF data is 3 bits, for example. The setting of the OF data indicates that the data to be written corresponding to the format 600 includes an application ID which will be described below, and is continuous with previously written data. By setting the OF data, the format 600 represents a write request that instructs a write operation and an ABO process.

The size of each of the application code 616, the first level order 618, the second level order 620, and the third level order 622 is 512 Kbytes, for example. The size of each of the application code 616, the first level order 618, the second level order 620, and the third level order 622 are not limited to 512 Kbytes, and may be appropriately selected based on the purpose, specifications, and the like of the memory system 1.

The application code 616, the first level order 618, the second level order 620, and the third level order 622 are set as shown in FIG. 12.

The application code 616 includes an application ID. The application ID is assigned an application-specific index such as #01 shown in FIG. 12, for example.

The first level order 618, the second level order 620, and the third level order 622 indicate a hierarchical structure of data included in the same application. For example, to explain the hierarchical structure of data by comparing to multiple apartment buildings, when one apartment building has three floors and each floor contains 10 rooms, for example, the first digit may indicate the building number, the next digit may indicate the floor, and the last two digits may indicate the room number, thereby setting each room in the apartment with a four-digit numerical value. Here, for example, room No. 5 on the first floor of the first building may be set as 1105, and room No. 10 on the second floor of the first building may be set as 1210. That is, for example, when the hierarchy is set to be deeper in the order of first level order 618, second level order 620, and third level order 622, the first level order 618 may be assigned to an apartment building number, the second level order 620 may be assigned to an apartment floor, and the third level order 622 may be assigned to an apartment room number.

Each of the first level order 618, the second level order 620, and the third level order 622 shown in FIG. 12 is assigned a positive integer of 1 to 3, 1 to 5, and 1 to 10, and are set to be deeper in the order of the first level order 618, the second level order 620, and the third level order 622. The memory system 1 shows three hierarchies of level orders as an example, but the number of hierarchies of the level orders is not limited to three. The number of hierarchies of the level orders may be selected as appropriate based on the purpose, specifications, and the like of the memory system 1. In the memory system 1, as an example, when the setting value of the first level order 618 is defined as x, the setting value of the second level order 620 is defined as y, and the setting value of the third level order 622 is defined as z, the first level order 618, the second level order 620, and the third level order 622 are represented by one unit, such as (x, y, z).

The first level order 618, the second level order 620, and the third level order 622 indicate a hierarchical structure of data included in the same application, and the hierarchy is information indicating the reading order and writing order of data included in the same application. That is, the memory controller 10 instructs the non-volatile memory 20 to write and read data in the order of data corresponding to the unit with the minimum setting value among (x, y, z).

### <2-2. Example of Operating Method of Memory System 1>

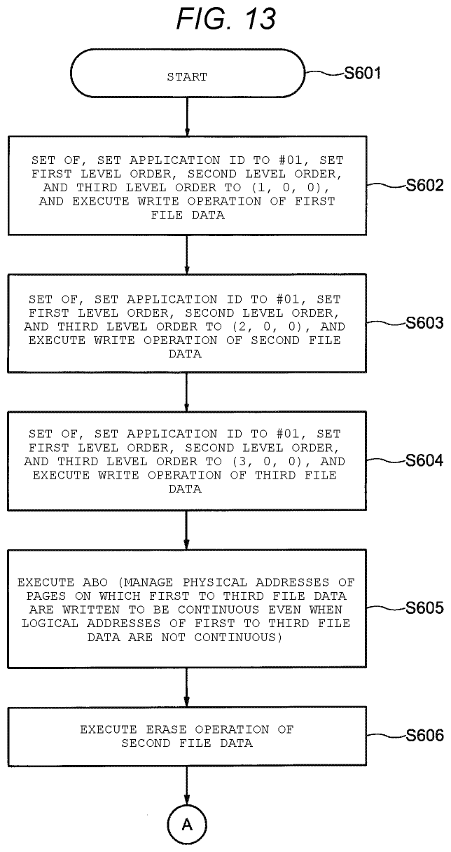

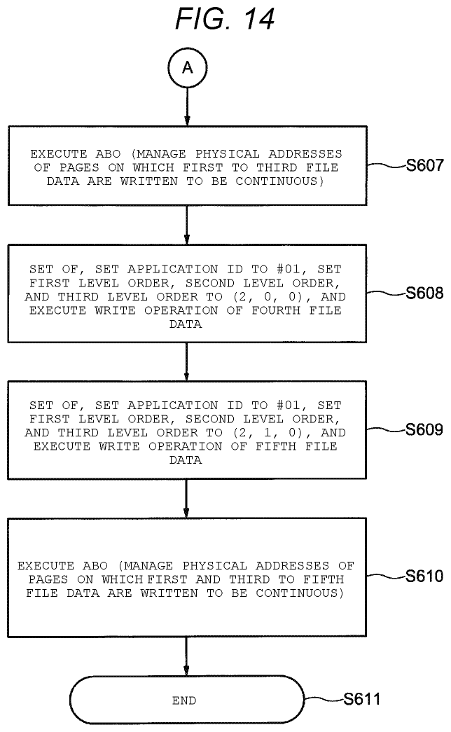

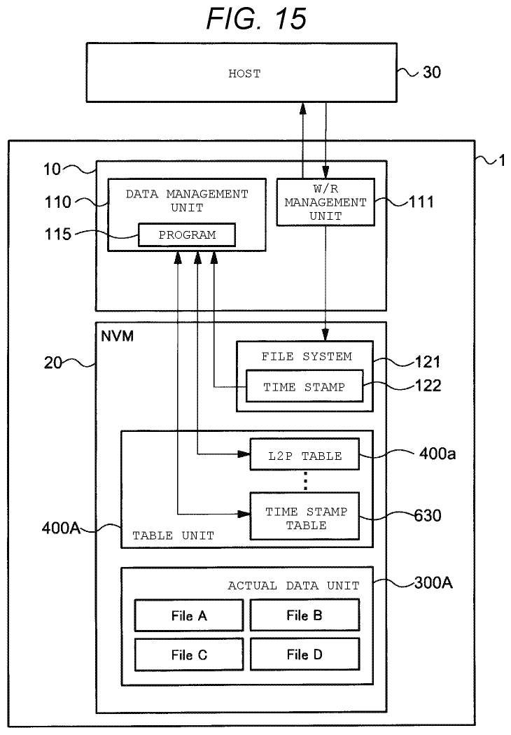

The operating method of the memory system 1 according to the second embodiment will be described with reference to FIGS. 13 and 14. FIGS. 13 and 14 are flowcharts showing the operating method of the memory system 1 according to the second embodiment.

The operating method of the memory system 1 according to the second embodiment includes transmitting a write request from the host 30 to the memory system 1 for writing a plurality of pieces of application file data (for example, File A to File C) including information included in data generated by the same application 32 and indicating a hierarchical structure indicating a reading order or a writing order. Each write request includes a write command WCMD that includes the format 600 shown in FIG. 11. The format 600 includes a 2nd OC corresponding to the write request, an application ID, and OF data that indicates that the data is continuous to previously written data and can set write and ABO process.

In the operating method of the memory system 1 according to the second embodiment, it is assumed, as an example, that the data generated by the application 32 includes five pieces of AFDs, that is, File A to File E, each having a TL of 512 Kbytes. File A to File E are referred to as first to fifth file data.

First, the host 30 starts a write operation (step S601). The host 30 sets the OC 602, the application code 616, the first level order 618, the second level order 620, the third level order 622, LBA and TL to 2nd OC, #01, (1, 0, 0), a predetermined address, and 512 Kbytes, and transmits the first write command WCMD including the format 600 set with OF and File A to the memory system 1 (step S602).

Next, the memory controller 10 receives the first write command WCMD including the format 600 from the host 30 and File A included in the application file data 321, and uses the W/R management unit 111 and the data management unit 110 to store File A in the non-volatile memory 20 based on the first write command WCMD (step S602). The OC 602, the application code 616, the first level order 618, the second level order 620, and the third level order 622, LBA, and TL of the format 600 included in the first write command WCMD are set to 2nd OC, #01, (1, 0, 0), LBA corresponding to File A, and 512 Kbytes, and OF is set.

After step S602, the host 30 executes step S603. The host 30 executes step S603 in which File A, the first write command WCMD, (1, 0, 0) of the first level order 618, the second level order 620, and the third level order 622, and the LBA corresponding to File A in step S602 are replaced with File B, the second write command WCMD, (2, 0, 0), and LBA corresponding to File B.

After step S603, the host 30 executes step S604. The host 30 executes step S604 in which File B, the second write command WCMD, (2, 0, 0) of the first level order 618, the second level order 620, and the third level order 622, and the LBA corresponding to File B in step S603 are replaced with File C, the third write command WCMD, (3, 0, 0), and LBA corresponding to File C.

The OF and hierarchical structure (first to third level order) are set for the first to third write commands WCMD, respectively. The data management unit 110 executes ABO process based on the OF and hierarchical structure set in the first to third write commands WCMD (step S605). The data management unit 110 may store File A, File B, and File C in the order of File A, File B, and File C in the pages corresponding to continuous physical addresses of the non-volatile memory 20 via the memory I/F. The data management unit 110 may manage application file data stored in the pages corresponding to continuous physical addresses of the non-volatile memory 20 in the order of the hierarchical structure of File A, File B, and File C.

Here, the data management unit 110 maps the LBAs of File A, File B, and File C with pages corresponding to continuous physical addresses of the non-volatile memory 20, and stores the mapping in at least one L2P table among the plurality of L2P tables included in the table unit 400.

Next, when the memory controller 10 receives an erase request including an erase command ERCMD, erase data (File B), and the like from the host 30, the memory controller 10 executes the erase operation described in “1-3. Configuration of Memory Controller 10” based on the erase command ERCMD, erase data, and the like (step S606).

Next, as the memory controller 10 executes the erase operation, the data management unit 110 executes the ABO process (step S607). That is, the data management unit 110 stores File A and File C in the order of the LBAs of File A and File C in the pages corresponding to continuous physical addresses of the non-volatile memory 20 via the memory I/F. The data management unit 110 maps the LBAs of File A, and File C with pages corresponding to continuous physical addresses of the non-volatile memory 20, and stores the mapping in at least one L2P table among the plurality of L2P tables included in the table unit 400.

After step S607, the host 30 executes step S608. The host 30 executes step S608 in which File C, the third write command WCMD, (3, 0, 0) of the first level order 618, the second level order 620, and the third level order 622, and the LBA corresponding to File C in step S604 are replaced with File D, a fourth write command WCMD, (2, 0, 0), and LBA corresponding to File D.

After step S608, the host 30 executes step S609. The host 30 executes step S609 in which File D, the fourth write command WCMD, (2, 0, 0) of the first level order 618, the second level order 620, and the third level order 622, and the LBA corresponding to File D in step S608 are replaced with File E, a fifth write command WCMD, (2, 1, 0), and LBA corresponding to File E.

Since the fourth write command WCMD and the fifth write command WCMD have the OF and hierarchical structure set, respectively, the data management unit 110 executes the ABO process based on the OF and hierarchical structure set in the fourth write command WCMD and the fifth write command WCMD, as in step 605 (step S610). As a result, the data management unit 110 may store File A, File D, File E, and File C in the order of File A, File D, File E, and File C in the pages corresponding to continuous physical addresses of the non-volatile memory 20 via the memory I/F based on (1, 0, 0), (3, 0, 0), (2, 0, 0), and (2, 1, 0), which are the hierarchical structures of File A, File C, File D, and File E, respectively. The data management unit 110 can manage application file data stored in the pages corresponding to continuous physical addresses of the non-volatile memory 20 in the order of File A, File D, File E, and File C.

Here, the data management unit 110 maps the hierarchical structure of File A, File D, File E, and File C with the pages corresponding to continuous physical addresses of the non-volatile memory 20, and stores the mapping in at least one L2P table among the plurality of L2P tables included in the table unit 400.

The data management unit 110 executes the ABO process and, when step S610 is completed, the write operation ends (step S611).

For example, after step S610, when the memory system 1 receives a read request including a read command RCMD from the host 30, and reads data from the non-volatile memory 20 based on the read command RCMD, File A, File D, File E, and File C may be read in this order based on the hierarchical structure and the L2P table in which pages corresponding to the physical addresses of each piece of data are stored.

The memory system 1 according to the second embodiment may execute the ABO process like the memory system 1 according to the first embodiment, and store a plurality of pieces of file data in the pages corresponding to continuous physical addresses of the non-volatile memory 20. Therefore, like the memory system 1 according to the first embodiment, the memory system 1 according to the second embodiment can shorten the time required to read file data when starting the application 32, and speed up the read operation of file data when starting the application 32.

### Third Embodiment

The memory system 1 according to a third embodiment will be described. The operating method of the memory system 1 according to the third embodiment is different from the operating method of the memory system 1 according to the first and second embodiments. The description of the memory system 1 according to the third embodiment will focus on the differences from the first embodiment.

### <3-1. Overall Configuration of Memory System 1>

FIG. 15 is a functional block diagram of the memory system 1 and the host 30 according to the third embodiment. Instead of the memory controller 10 using the data management unit 110 and the W/R management unit 111 to execute the ABO process based on the write command WCMD from the host 30, the operating method of the memory system 1 according to the third embodiment includes the data management unit 110 of the memory controller 10 analyzing a file system 121 and acquiring time information. The file system 121 includes metadata (for example, a time stamp 122, and the like) including the time when the data was stored in the non-volatile memory 20, which is data for the host 30 to manage information about files and directories, and is a data format for managing file data stored in the non-volatile memory 20 and the address where the data is stored.

The data management unit 110 identifies the time stamp 122 included in the file system 121 according to the type of file system, and reads the identified time stamp 122 as time information. An area where the time stamp 122 exists differs depending on the file system.

The data management unit 110 includes a program 115, for example. The program 115 is a program that periodically reads the file system 121, analyzes the data structure of the file system 121, and determines whether the data includes the time stamp 122. Specifically, the program 115 may analyze a plurality of representative file systems.

The data management unit 110 periodically executes the program 115. The data management unit 110 may store and manage a cumulative write amount obtained by counting the number of times the write command WCMD was received from the host 30. For example, the data management unit 110 may count the number of times the read command RCMD received from the host 30, and store and manage a cumulative read amount. The data management unit 110 may execute the program 115 each time the write command WCMD or the read command RCMD is received.

For example, the data management unit 110 executes the program 115, reads the file system 121, analyzes the data structure of the file system 121, and determines whether the data includes the time stamp 122 each time the cumulative read amount is 100 Gbytes or the cumulative write amount is 100 Gbytes.

### <3-2. Operating Method of Memory System 1>

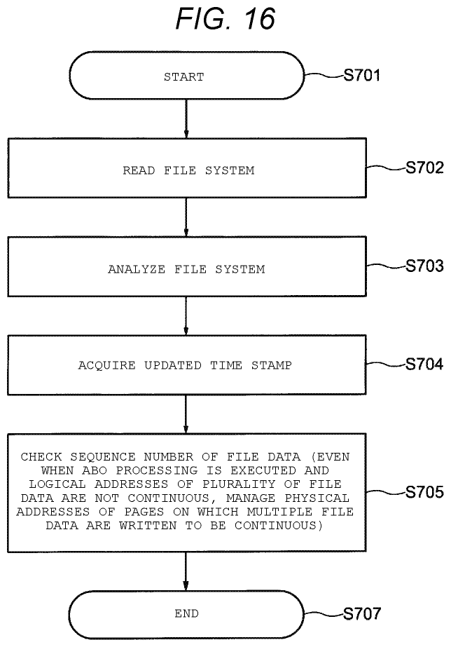

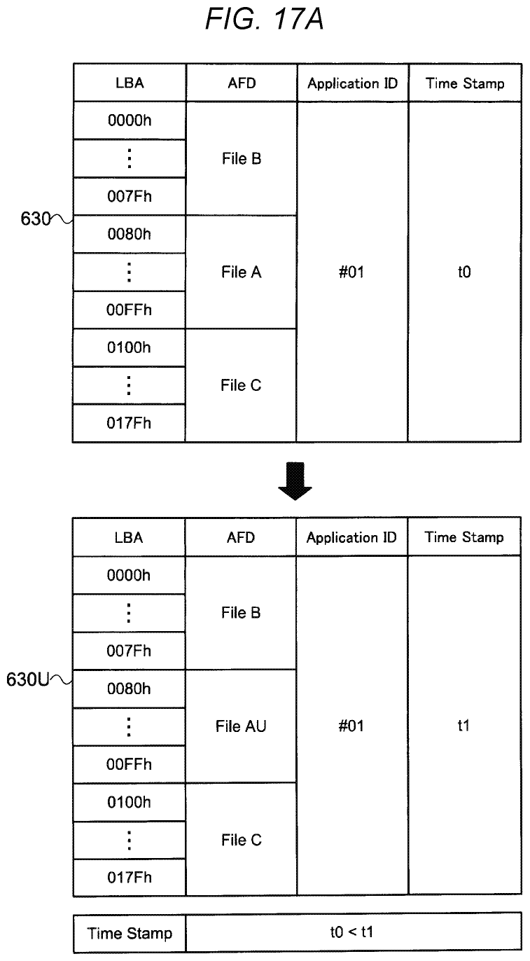

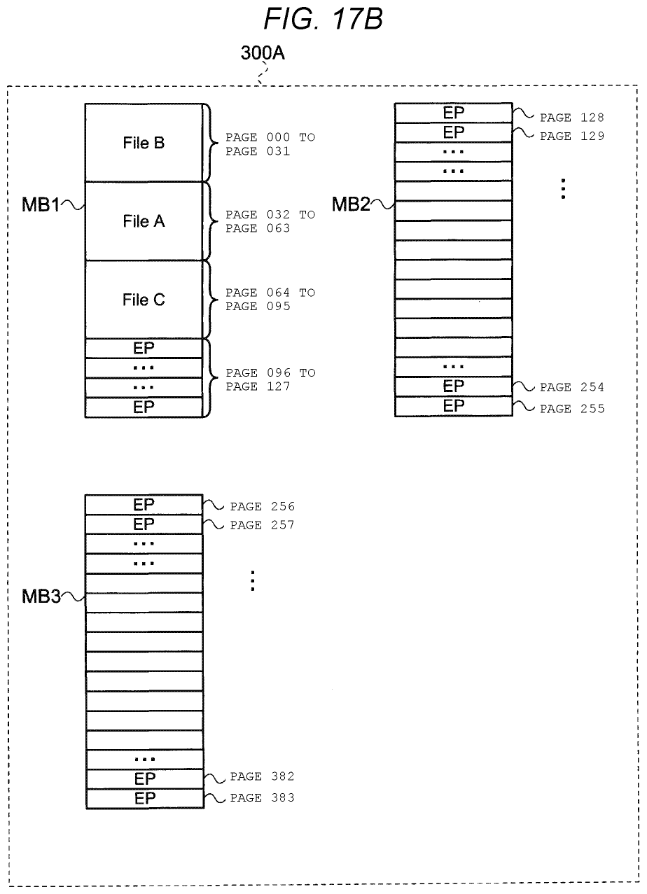

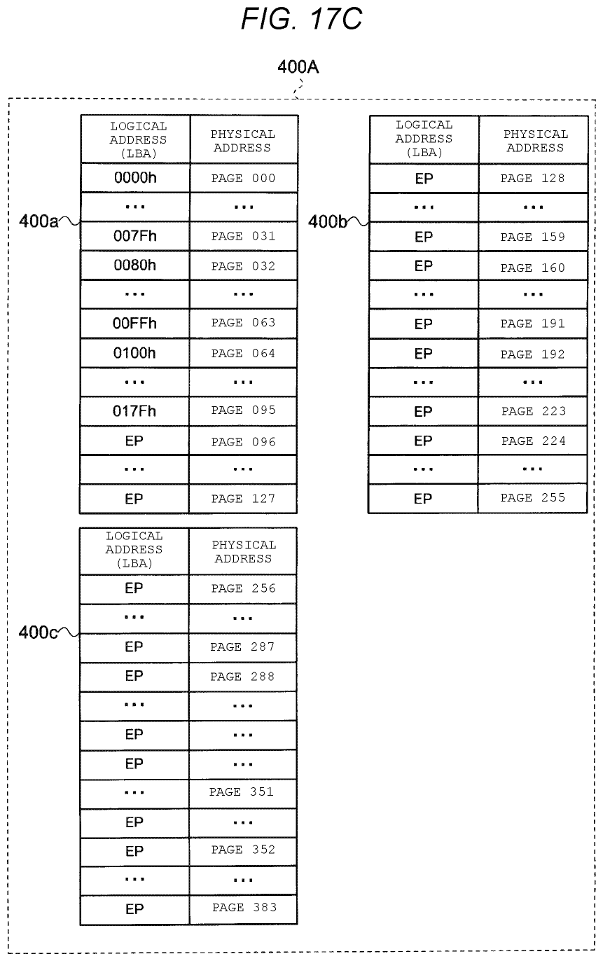

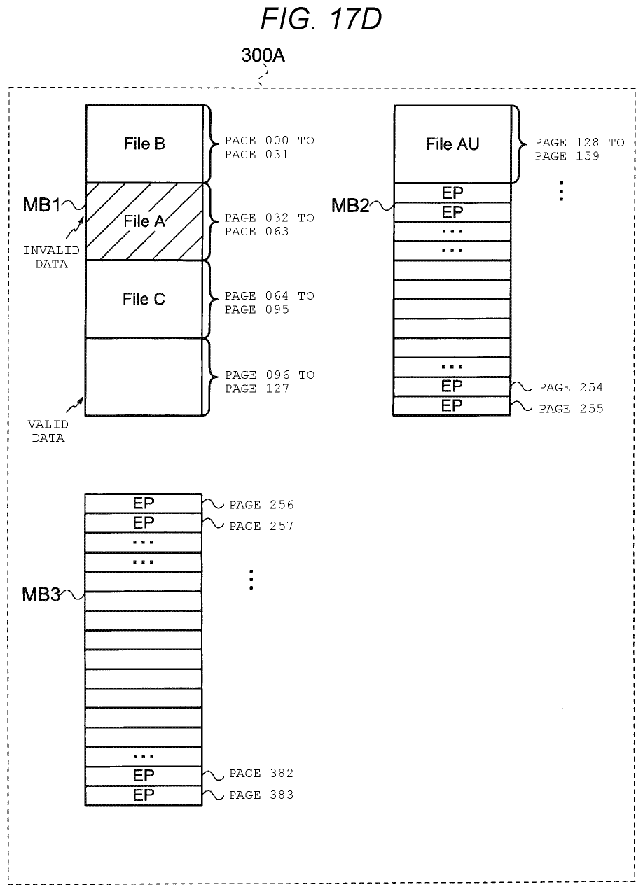

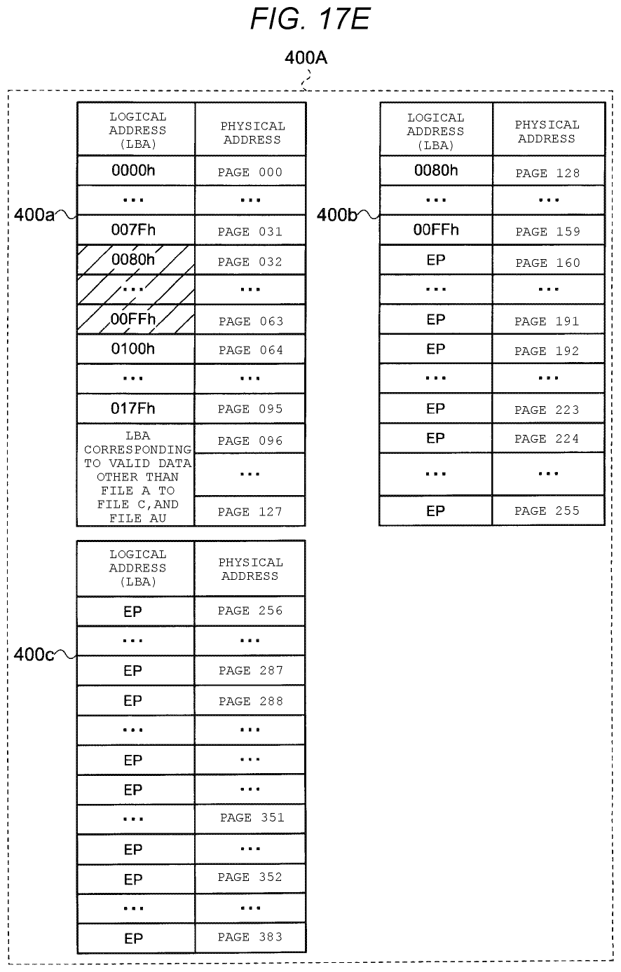

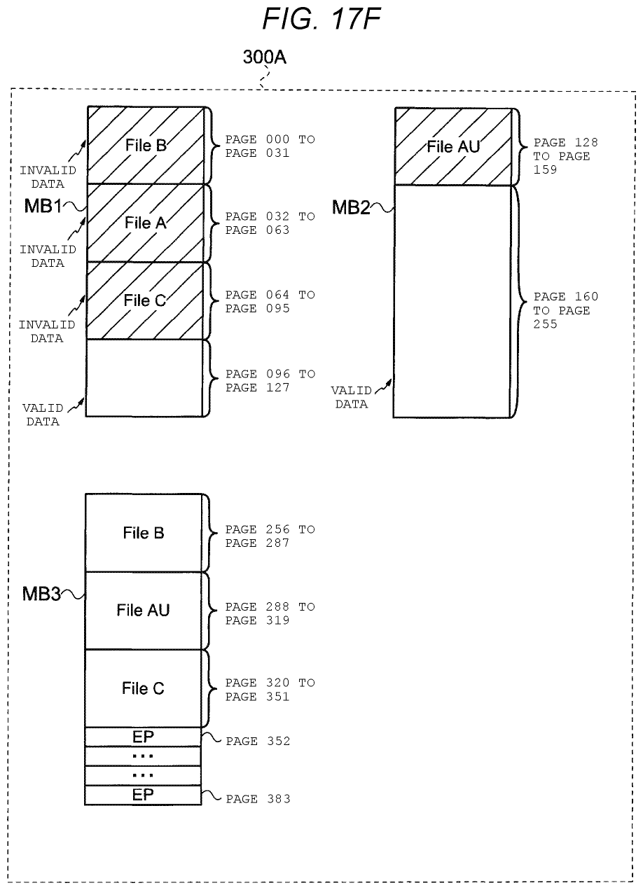

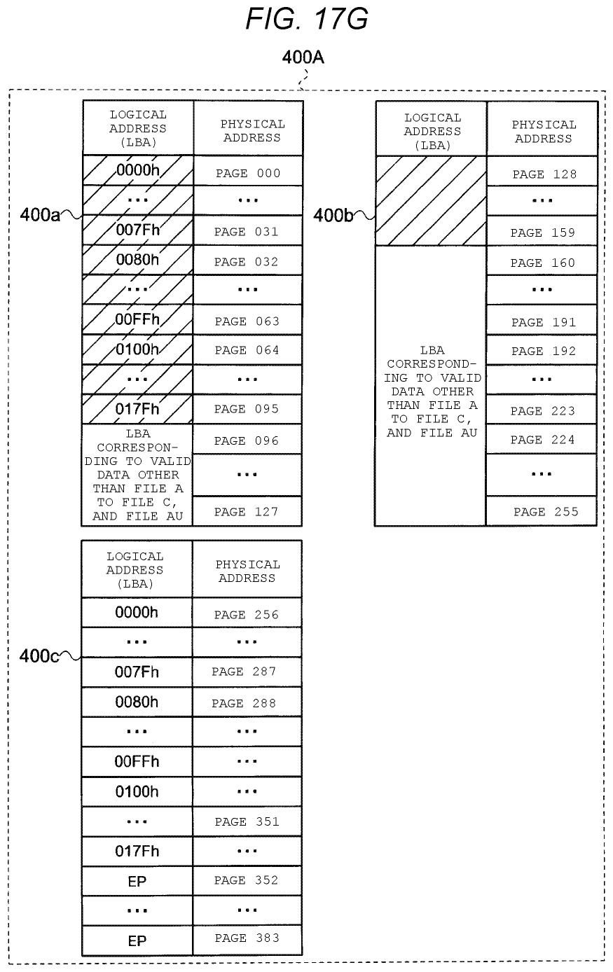

An operating method of the memory system 1 according to the third embodiment will be specifically described with reference to FIGS. 16 to 17G. FIG. 16 is a flowchart showing the operating method of the memory system 1 according to the third embodiment. FIG. 17A is a diagram showing a configuration of a time stamp table 630 according to the third embodiment. FIGS. 17B, 17D, and 17F are diagrams showing a configuration of an actual data unit 300A according to the third embodiment. FIGS. 17C, 17E, and 17G are diagrams showing a configuration of an L2P table 400A according to the third embodiment.

For example, when the memory controller 10 receives the write command WCMD or the read command RCMD from the host 30, the memory controller 10 starts counting the number of times the write command WCMD or read command RCMD was received (step 701).

The data management unit 110 reads the file system 121 for every certain amount of cumulative read amount or cumulative write amount, for example (step S702). After reading the file system 121, the data management unit 110 analyzes the data structure of the file system 121 (step S703). It is determined whether data within the data structure includes the time stamp 122. When it is determined that the data in the data structure includes the time stamp 122, the data management unit 110 stores time information corresponding to the time stamp 122 in the time stamp table 630.

For example, in the time stamp table 630, the LBA, AFD, application ID, and the time stamp 122 shown in FIG. 17A are mapped to each other. LBA 0000h to 007Fh, File A, application ID #01 (application 32), and time t0 of the time stamp 122 are mapped to each other. Like File A, File B and File C are mapped as shown in FIG. 17A. Here, File A is updated to File AU from time t0 to time t1. File B, File A, and File C generated using the same application 32 (application ID is #01) are stored in the memory block in this order.

FIG. 17B is a diagram schematically showing the data arrangement in the actual data unit 300A after the execution of the process described below, for example. The actual data unit 300A includes the memory blocks MB1 to MB3, for example.

The host 30 generates File B, File A, and File C and transmits the files to the memory system 1. The memory system 1 stores File B, File A, and File C in page 000 to page 095 corresponding to the physical addresses of the memory block MB1.

As shown in the table unit 400A in FIG. 17C, the table unit 400A includes the first L2P table 400a, the second L2P table 400b, and the third L2P table 400c, for example. The table unit 400A in FIG. 17C corresponds to the actual data unit 300A shown in FIG. 17B. In the first L2P table 400a, LBA 0000h to 017Fh are mapped to File B, File A, and File C (page 000 to page 095 corresponding to physical addresses). The configurations of the memory blocks MB1 to MB3, the first L2P table 400a, the second L2P table 400b, and the third L2P table 400c are similar to those in the first embodiment, and detailed descriptions thereof will be omitted here.

For example, the memory controller 10 receives a write request including the write command WCMD and write data (File B, File A, and File C) from the host 30, and executes the write operation described in “1-3. Configuration of Memory Controller 10” based on the write command WCMD and the write data (File B, File A, and File C), thereby configuring the time stamp table 630 shown in FIG. 17A, and the actual data unit 300A and the table unit 400A shown in FIGS. 17B and 17C. When File A to File C are updated, for example, the memory controller 10 executes the write operation described in “1-6. First Example of Operating Method of Memory System 1 (First Example)”, thereby configuring a time stamp table 630U shown in FIG. 17A, and the actual data unit 300A or the table unit 400A shown in FIGS. 17D and 17E.

When the time stamp 122 is updated, for example, the time stamp table 630 is updated to the time stamp table 630U, the actual data unit 300A shown in FIG. 17B is updated to the actual data unit 300A shown in FIG. 17D, and the table unit 400A shown in FIG. 17C is updated to the table unit 400A shown in FIG. 17E. The page storing File A is updated from page 032 to page 063 to page 128 to page 159 at time t1 based on the time stamp table 630U and the actual data unit 300A shown in FIG. 17D.

FIG. 17D is a diagram schematically showing the data arrangement in the actual data unit 300A after File B, File A, and File C are stored in page 000 to page 095 corresponding to the physical address of memory block MB1 and the process described below is executed, for example.

The host 30 generates data other than File A to File C and File AU and transmits the generated data to the memory system 1. The memory system 1 stores the other data in page 096 to stored in page 096 to page 127, and is file data of page 096 to page 127 of the physical addresses mapped to LBAs corresponding to valid data other than File A to File C and File AU in the table unit 400A of FIG. 17E.

Then, the host 30 updates File A to File AU and transmits the updated file to the memory system 1. The memory system 1 stores File AU in page 128 to page 159 of memory block MB2.

The table unit 400A in FIG. 17E corresponds to the actual data unit 300A shown in FIG. 17D. In the first L2P table 400a, LBA 0000h to 007Fh are mapped to File B (page 000 to page 031 of the physical addresses), LBA 0100h to 017Fh are mapped to File C (page 064 to page 095 of the physical addresses), and LBAs corresponding to valid data other than File A to File C, File BU, and File CU are mapped to page 096 to page 127 of the physical addresses. In the second L2P table 400b, LBA 0080h to 00FFh are mapped to File AU (page 128 to page 159 of the physical addresses).

The erased pages (EPS) shown in FIGS. 17B to 17E are pages in which there is no mapping between physical addresses and logical addresses in the actual data unit 300A and the table unit 400A. As shown in FIGS. 17D and 17E, File B (page 032 to 0080h to 00FFh in the first L2P table 400a is no longer mapped (described as invalid data in FIG. 17D).

The description will be continued with reference to FIG. 16 again. The data management unit 110 reads the time stamp table 630U and acquires time information corresponding to the updated time stamp 122 (step S704).

When the data management unit 110 acquires the time stamp 122 as the time information, the data management unit 110 reads the updated table unit 400A shown in FIG. 17E and checks the order of the file data (step 705). Specifically, the data management unit 110 reads the first L2P table 400a and the second L2P table 400b shown in FIG. 17E, and confirms that LBA 0000h to 007Fh are mapped to page 000 to page 031 of the physical addresses, LBA 0100h to 017Fh are mapped to page 064 to page 095 of the physical addresses, and LBA 0080h to 00FFh are mapped to page 128 to page 159 of the physical addresses. The data management unit 110 confirms that File B is stored in page 000 to page 031, File C is stored in page 064 to page 095, and File AU is stored in page 128 to page 159 of the physical addresses of the updated actual data unit 300A shown in FIG. 17D in this order.

The data management unit 110 executes the ABO process described in the first embodiment and the second embodiment based on the file update.

FIG. 17F is a diagram schematically showing the data arrangement in the actual data unit 300A after File AU is stored in page 128 to page 159 corresponding to the physical address of memory block MB2 and the ABO process is executed, for example.

The host 30 generates data different from File A to File C, File AU, and the data stored in page 128 to page 159, and transmits the generated data to the memory system 1. The memory system 1 stores the other data in page 160 to page 255 of the memory block MB2. The other data is valid data stored in page 160 to page 255, and is file data of page 160 to page 255 of the physical addresses mapped to LBAs corresponding to valid data other than File A to File C and File AU in the table unit 400A of FIG. 17G.

As a result, the data management unit 110 may store File B, File AU, and File C corresponding to continuous LBAs 0000h to 017Fh in the page 256 to page 351 corresponding to continuous physical addresses of the memory block MB3 in the order of the corresponding LBAs, as shown in the actual data unit 300A shown in FIG. 17F. The data management unit 110 maps page 256 to page 352 of the physical addresses with LBA 0000h to 017Fh and stores the result in the third L2P table 400c, as shown in the table unit 400A shown in FIG. 17G. That is, File B, File AU, and File C stored in page 256 to page 352 are valid data. As shown in FIG. 17G, File AU (page 128 to page 159 of the physical addresses) that corresponded to LBA 0080h to 00FFh of the second L2P table 400b and File AU (page 128 to page 159 of the physical addresses) of the memory block MB2 are no longer mapped (described as invalid data in FIG. 17F). In the third embodiment, the mapping of the LBA of invalid data (shaded area) may not exist, and mapping indicating that the LBA of the first L2P table 400a, the second L2P table 400b, and the third L2P table 400c is EP may not exist.

When the data management unit 110 confirms that File B, File AU, and File C are stored in this order, the operating method of the memory system 1 according to the third embodiment ends (step S707).

The memory system 1 according to the third embodiment may execute the ABO process like the first and second embodiments, and store a plurality of pieces of file data corresponding to continuous LBAs generated using the same application 32 in the pages corresponding to continuous physical addresses of the non-volatile memory 20 in the order of corresponding logical addresses. Therefore, like the first and second embodiments, the memory system 1 according to the third embodiment can shorten the time required to read file data when starting the application 32, and speed up the read operation of file data when starting the application 32.

### Fourth Embodiment

The memory system 1 according to a fourth embodiment will be described. An operating method of the memory system 1 according to the fourth embodiment is different from the operating method of the memory system 1 according to the first embodiment. The description of the memory system 1 according to the fourth embodiment will focus on the differences from the first embodiment.

### <4-1. Overall Configuration of Memory System 1>

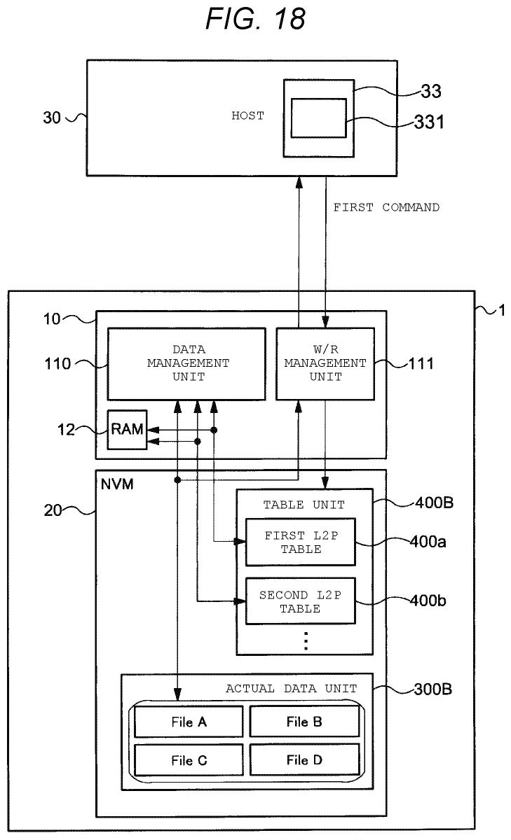

The functional block configurations of the memory system 1 and the host 30 according to the fourth embodiment will be described with reference to FIG. 18. FIG. 18 is a functional block diagram of the memory system 1 and the host 30 according to the fourth embodiment.

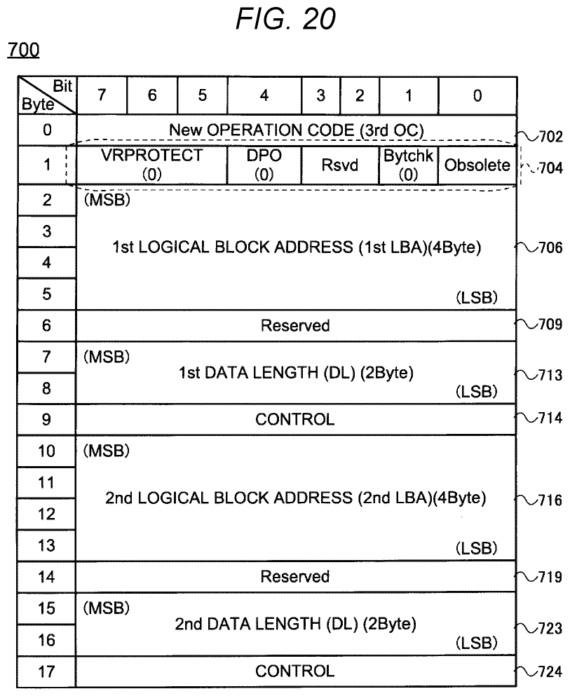

The operating method of the memory system 1 according to the fourth embodiment includes the memory controller 10 performing a process of concatenating at least two AFDs (for example, File B and File D) generated using the same application 33, and performing the ABO process using the data management unit 110 and the W/R management unit 111 based on a first command from the host 30. The first command includes a format 700 shown in FIG. 20. The format 700 includes a third operation command (3rd OC) corresponding to the first command, a first LBA (1st LBA), a first data length (1st DL), a second LBA (2nd LBA), and a second data length (2nd DL).

In response to the first command received from the host 30, the W/R management unit 111 instructs the non-volatile memory 20 to execute a process of concatenating at least two AFDs generated using the same application 33.

In response to the first command received from the host 30, the data management unit 110 reads the L2P table included in the table unit 400 into the RAM 12, loads the read table onto the RAM 12, and updates the management information in the L2P table, for example.

### <4-2. Structure of Data Generated by Application 33>

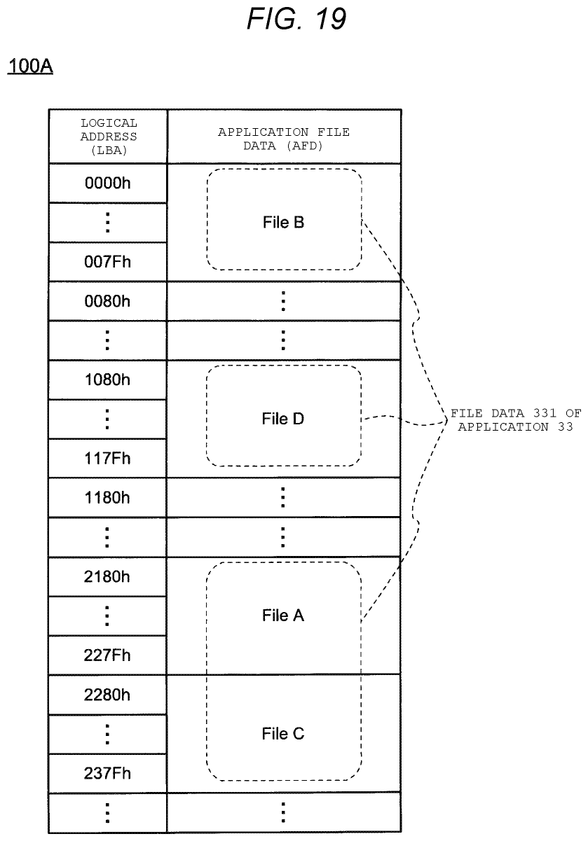

A structure of data generated by the application 33 will be described with reference to FIG. 19. FIG. 19 is a diagram showing a structure of data generated by the application 33 according to the fourth embodiment. The data generated by the application 33 includes an AFD 331. The data generated by the application 33 is specified by a logical address of the host 30. In a logical address space 100A, AFDs are mapped to logical addresses.

The AFD 331 includes File A to File D generated using the same application 33, for example. File B is mapped to LBA 0000h to 007Fh, File D is mapped to LBA 1080h to 117Fh, File A is mapped to LBA 2180h to 227Fh, and File C is mapped to LBA 2280h to 237Fh. That is, in the memory system 1 according to the fourth embodiment, File B, File D, File A, and File C are not mapped to continuous logical addresses.

### <4-3. Format 700>

The format 700 of the first command will be described with reference to FIG. 20. FIG. 20 is a diagram showing an example of the format 700 of the first command according to the fourth embodiment. The format 700 differs from the format 500 according to the first embodiment in the 3rd OC, the 1st LBA, the 1st DL, the 2nd LBA, and the 2nd DL. Like the format 500, the codes, data, values, and the like set in the format 700 are referred to as setting information.

The format 700 includes an OC 702, a plurality of individual setting codes 704, a 1st LBA 706, reserved areas (Reserved) 709 and 719, a 1st DL 713, a 2nd LBA 716, a 2nd DL 723, and control bytes 714 and 724. That is, the format 700 includes two continuous LBAs (1st LBA 706 and 2nd LBA 716), and includes the 1st DL 713 and the 2nd DL 723 corresponding to the respective data lengths of the 1st LBA 706 and the 2nd LBA 716.

The plurality of individual setting codes 704, reserved areas 709 and 719, and control bytes 714 and 724 are the same as the plurality of individual setting codes 504, the reserved area 509, and the control byte 514, and a description thereof will be omitted. The 1st LBA 706 and the 2nd LBA 716 are the same as the LBA 506, and the 1st DL 713 and the 2nd DL 723 are the same as the TL 512.

The OC 702 indicates that the transferred block (for example, command, descriptor block) is a request to concatenate at least two AFDs and to execute ABO process, and includes the third operation code (3rd OC).

### <4-4. Operating Method of Memory System 1>

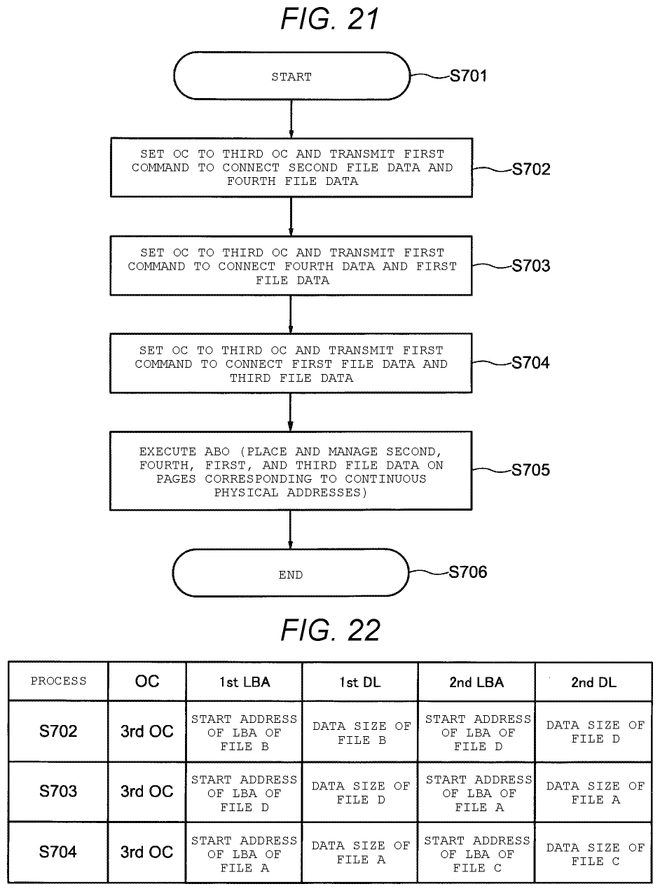

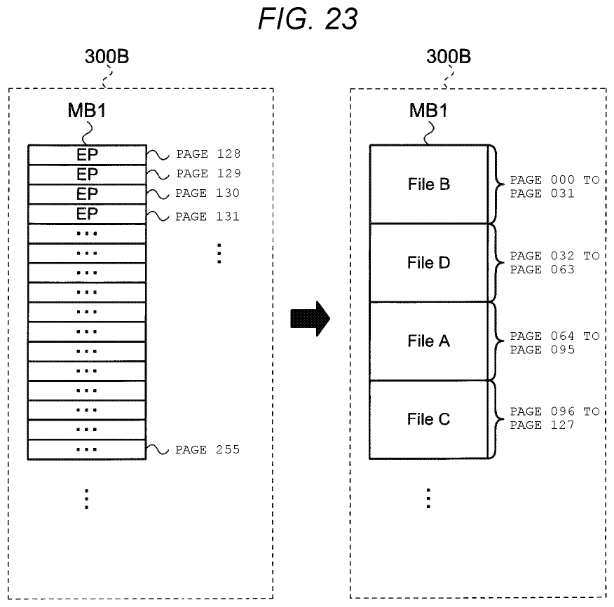

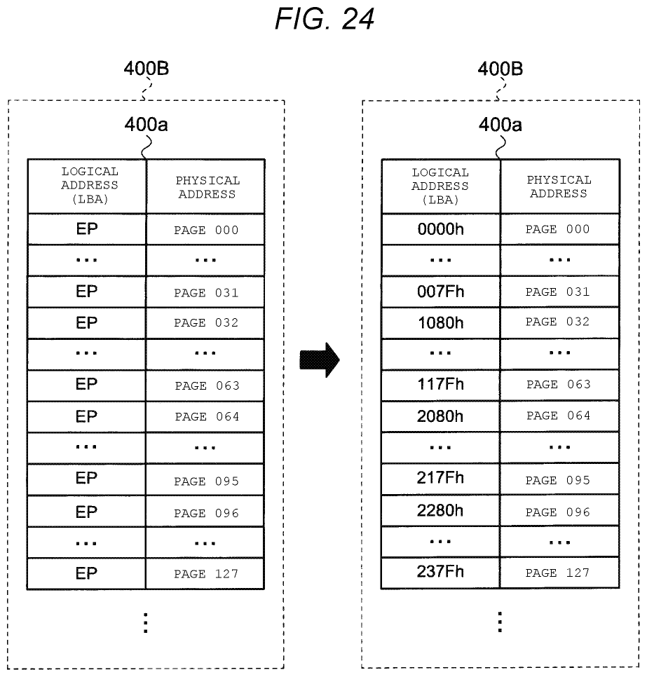

An operating method of the memory system 1 according to a fourth embodiment will be described with reference to FIGS. 21 to 24. FIG. 21 is a flowchart showing the operating method of the memory system 1 according to the fourth embodiment. FIG. 22 is a diagram showing an example of the settings of the first command shown in FIG. 20. FIG. 23 is a diagram showing a configuration of an actual data unit 300B and a table unit 400B according to the fourth embodiment, and FIG. 24 is a diagram showing a configuration of the table unit 400B according to the fourth embodiment. In the operating method of the memory system 1 according to the fourth embodiment, as an example, it is assumed that the data generated by the application 33 includes four AFDs, that is, File A to File D, each having a DL of 512 Kbytes. File A to File D are referred to as first to fourth file data.

First, the host 30 starts an operation of concatenating a plurality of AFDs (step S701). The host 30 transmits, to the memory system 1, a first command including the format 700 in which the OC 702, the 1st LBA, the 1st DL, the 2nd LBA, and the 2nd DL are set to the 3rd OC, an LBA start address of File B, 512 Kbytes, an LBA start address of File D, and 512 Kbytes shown in FIG. 22, and the memory controller 10 receives the first command including the format 700 from the host 30 (step S702). The start address is an address where the start address is set and indicates the reading order or writing order of the AFD, for example. The LBA start address of File B is smaller than the LBA start address of File D. The memory controller 10 stores File B before File D and reads File B before File D.

After step S702, the memory system 1 executes step S703. The memory system 1 transmits, to the memory controller 10, a first command in which the format 700 set to the 3rd OC, the LBA start address of File B, 512 Kbytes, the LBA start address of File D, and 512 Kbytes in step S702 are replaced with the format 700 set to the 3rd OC, the LBA start address of File D, 512 Kbytes, an LBA start address of File A, and 512 Kbytes shown in FIG. 22, and the memory controller 10 receives the first command including the format 700 from the host 30 (step S703). The LBA start address of File D is smaller than the LBA start address of File A. The memory controller 10 stores File D before File A, and reads File D before File A.

Next, the memory controller 10 executes step S704. The operating method of the memory system 1 in step S704 is an operating method in which File B and File D in step S703 are replaced with File A and File C. The LBA start address of File A is smaller than an LBA start address of File C. The memory controller 10 stores File A before File C, and reads File A before File C.

When step S704 ends, the memory controller 10 concatenates File B, File D, File A, and File C corresponding to continuous logical addresses in this order using the W/R management unit 111 and the data management unit 110 based on each first command received in steps S702 to S704, and also instructs the non-volatile memory 20 to execute the process (ABO process) of storing data in the pages corresponding to continuous physical addresses (step S705). The memory controller 10 stores File B, File D, File A, and File C in this order in the pages corresponding to continuous physical addresses.

For example, as shown in FIG. 23, the non-volatile memory 20 stores the file data in the memory block MB1 (page with no mapping between logical addresses and physical addresses (EP)) included in the actual data unit 300B. Specifically, the memory controller 10 stores File B in page 000 to page 031, stores File D in page 032 to page 063, stores File A in page 064 to page 095, and stores File C in page 096 to page 127.

As shown in FIG. 24, the data management unit 110 makes a page with no mapping between logical addresses and physical addresses (EP) in the first L2P table 400a included in the table unit 400B into a state where valid data is stored. Specifically, the data management unit 110 maps the physical addresses of page 000 to page 032 with logical addresses 0000h to 007Fh, maps the physical addresses of page 033 to page 063 with logical addresses 1080h to 117Fh, maps the physical addresses of page 064 to page 095 with logical addresses 2080h to 217Fh, and maps the physical addresses of page 096 to page 0127 with logical addresses 2280h to 237Fh. The states of the actual data unit 300B and the table unit 400B at the end of step S705 are the states shown in FIGS. 23 and 24.

The data management unit 110 executes the ABO process, and when step S705 is completed, the write operation ends (step S706).

For example, after step S706, when the memory system 1 receives a read request including a read command RCMD from the host 30 and reads data from the non-volatile memory 20 based on the read command RCMD, File B, File D, File A, and File C may be read in this order.

With the operating method of the memory system 1 according to the fourth embodiment, by using the first command for concatenating at least two AFDs to concatenate the two AFDs in advance without the two AFDs being separated, the two AFDs can be stored in the pages corresponding to continuous physical addresses. As a result, the number of commands that the memory system 1 receives from the host 30 can be reduced compared to when a plurality of AFDs are written individually and the AFDs are stored in the pages corresponding to continuous physical addresses using the ABO process. Therefore, the operating method of the memory system 1 according to the fourth embodiment can reduce the number of GC processes and extend the lifetime of the non-volatile memory 20. The operating method of the memory system 1 according to the fourth embodiment allows a plurality of AFDs to be stored in the pages corresponding to continuous physical addresses, even when the logical addresses of the plurality of AFDs are separated from each other. Therefore, like the first to third embodiments, the memory system 1 according to the fourth embodiment can shorten the time required to read file data when starting the application 33, and speed up the read operation of file data when starting the application 33.

### Fifth Embodiment

The memory system 1 according to a fifth embodiment will be described. An operating method of the memory system 1 according to the fifth embodiment is an operating method related to the application-specific L2P table 410 of the memory system 1 according to the first embodiment. The description of the memory system 1 according to the fifth embodiment will focus on the differences from the first embodiment.

### <5-1. Overall Configuration of Memory System 1>

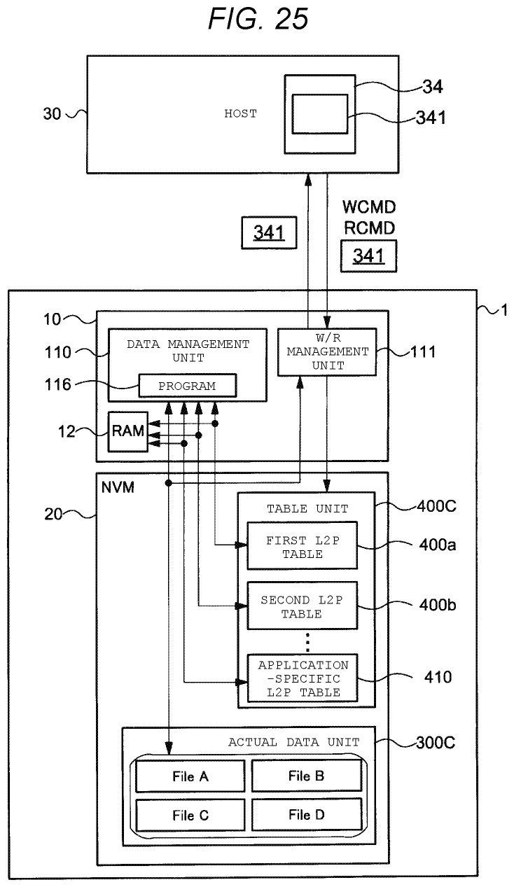

The functional block configurations of the memory system 1 and the host 30 according to the fifth embodiment will be described with reference to FIG. 25. FIG. 25 is a functional block diagram of the memory system 1 and the host 30 according to the fifth embodiment.

The operating method of the memory system 1 according to the fifth embodiment includes the memory controller 10, using the data management unit 110 and the W/R management unit 111 to execute write operations for a plurality of AFDs 341 (for example, File A to File D) generated using the same application 34 based on the write command WCMD from the host 30, executing the ABO process after executing the write operations, and generating an application-specific L2P table after executing the ABO process. The write command WCMD includes the format 500 shown in FIG. 8 according to the first embodiment, for example. The application-specific L2P table 410 stores information that maps the logical addresses of a plurality of AFDs generated using the same application 34 with pages corresponding to the physical addresses, as in the first embodiment.

The operating method of the memory system 1 according to the fifth embodiment includes executing a write operation based on the write command WCMD including the format 500, as an example. The format corresponding to the operating method of the memory system 1 according to the fifth embodiment is not limited to the format 500. For example, the format may be the format 600 or the format 700. The format can be selected as appropriate based on the purpose, specifications, and the like of the memory system 1.

The data management unit 110 includes a program 116, for example. The program 116 is a program that generates the application-specific L2P table 410 upon receiving completion of the ABO process.

In the operating method of the memory system 1 according to the fifth embodiment, after executing the ABO process, the data management unit 110 executes the program 116 upon receiving completion of the ABO process, and generates the application-specific L2P table 410.

### <5-2. Structure of Data Generated by Application 34>

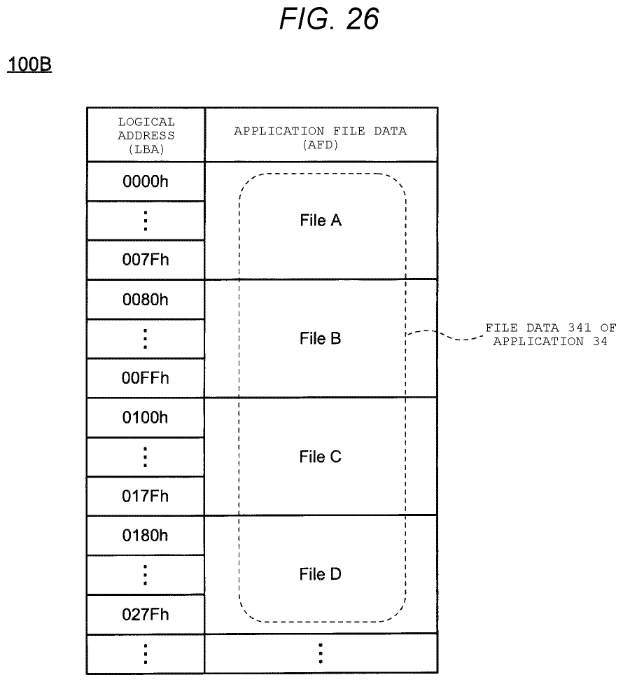

The structure of data generated by the application 34 will be described with reference to FIG. 26. FIG. 26 is a diagram showing a structure of data generated by the application 34 according to the fifth embodiment. The data generated by the application 34 includes an AFD 341. The data generated by the application 34 is specified by a logical address of the host 30.

The AFD 341 includes File A to File D, for example. File A to File D are mapped to LBA 0000h to 027Fh corresponding to continuous logical addresses. In the operating method of the memory system 1 according to the fifth embodiment, it is assumed, as an example, that the data generated by the application 34 includes four AFDs, that is, File A to File D, each having a TL of 512 Kbytes. File A to File D are referred to as first to fourth file data.

### <5-3. Configuration of Actual Data Unit 300C and Table Unit 400C>

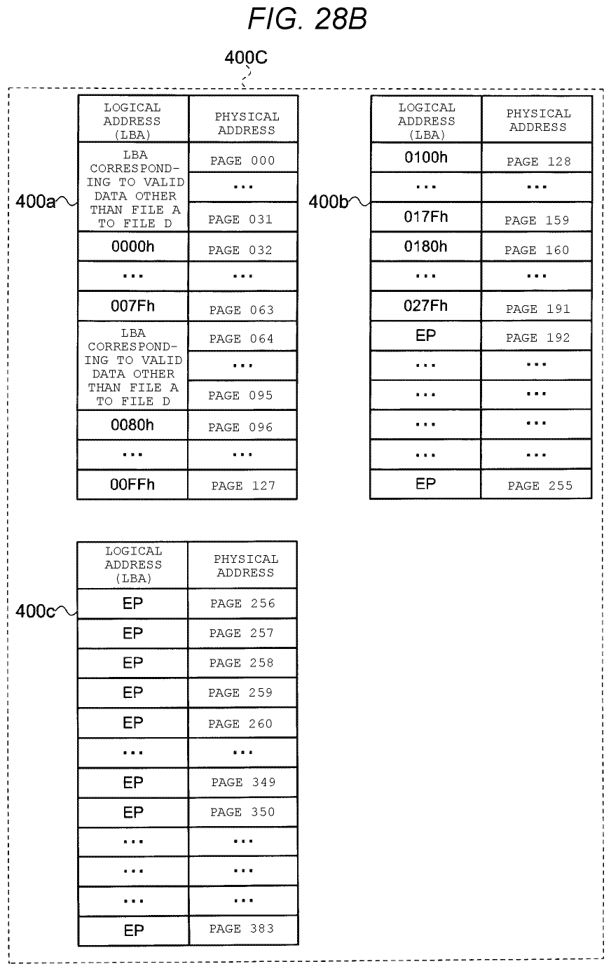

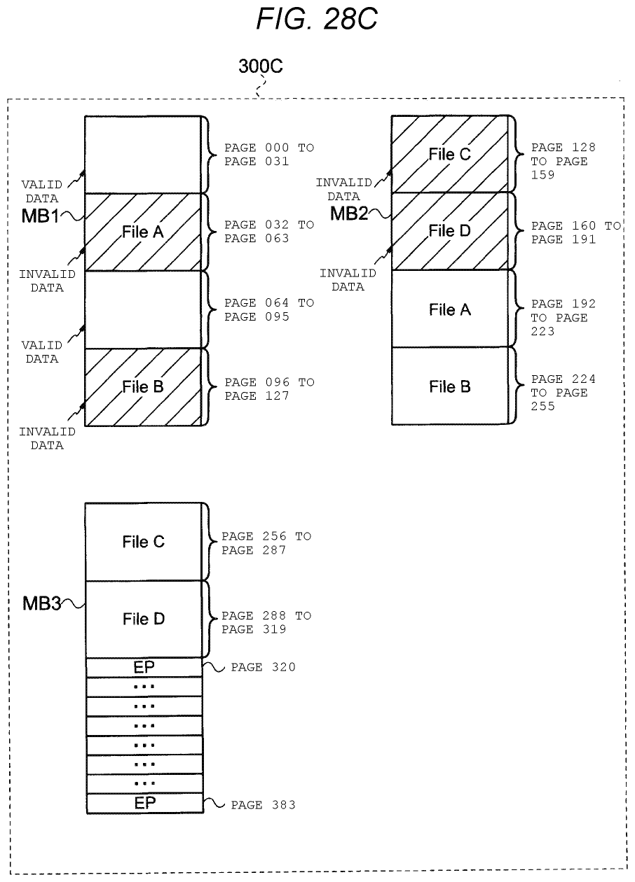

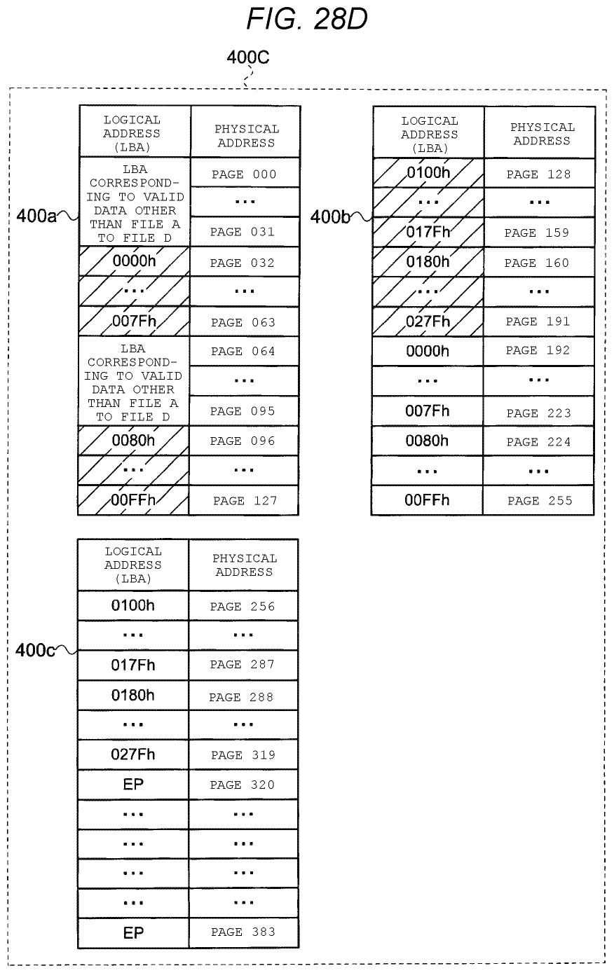

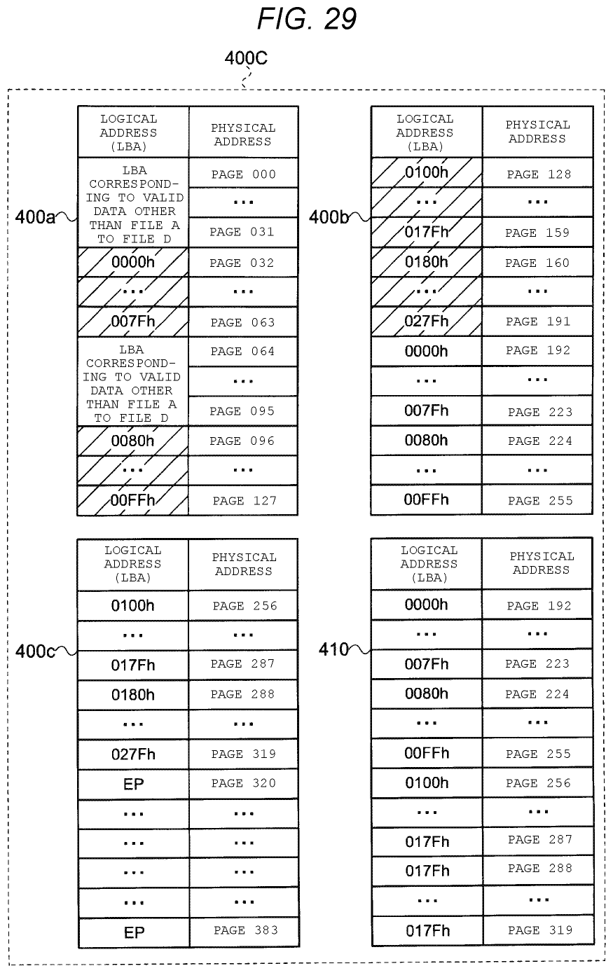

The configurations of an actual data unit 300C and a table unit 400C will be described with reference to FIGS. 28A and 28B. FIG. 28A shows a state in which the memory system 1 receives a write request, executes a write operation based on the write command WCMD, and File A to File D of the AFD 341 are stored in the non-volatile memory 20. The actual data unit 300C includes the memory blocks MB1 to MB3, for example.

FIG. 28A is a diagram schematically showing a data arrangement in the actual data unit 300C after the execution of the process described below, for example.

The host 30 generates data different from File A to File D and transmits the result to the memory system 1. The memory system 1 stores the other data in page 000 to page 031 of the memory block MB1. The other data is valid data stored in page 000 to page 031, and is file data in page 000 to page 031 of the physical addresses mapped to LBAs corresponding to valid data other than File A to File D in the table unit 400C of FIGS. 28B, 28D, and 29.

Then, the host 30 generates File A and transmits the result to the memory system 1. The memory system 1 stores File A in page 032 to page 063 of the memory block MB1. The host 30 generates data different from the data stored in page 000 to memory system 1 stores the other data received from the host 30 in page 064 to page 095 of the memory block MB1. The other data is valid data stored in page 064 to page 095, and is file data in page 064 to page 095 of the physical addresses mapped to LBAs corresponding to valid data other than File A to File D in the table unit 400C of FIGS. 28B, 28D, and 29.

Then, the host 30 generates File B to File D and transmits the files to the memory system 1. The memory system 1 stores File B to File D in page 096 to page 127 of the memory block MB1 and page 128 to page 223 of the memory block MB2. Page 192 to page 255 of MB2 and page 256 to page 383 of MB3 are pages that have no mapping between physical addresses and logical addresses in the actual data unit 300C and the table unit 400C, and are erased pages (EPs).

As shown in FIG. 28B, the table unit 400C includes three L2P tables (the first L2P table 400a, the second L2P table 400b, and the third L2P table 400c), for example. In the first L2P table 400a, page 000 to page 031 of the physical addresses are mapped to LBAs corresponding to valid data other than File A to File D, and the file data of page 000 to page 031 are valid data. Page 032 to page 063 of the physical addresses are mapped to 0000h to 007Fh of the logical addresses, and File A stored in physical addresses are mapped to LBAs corresponding to valid data other than File A to File D, and file data from page 064 to page 095 of the physical addresses are valid data. Page 096 to page 127 of the physical addresses are mapped to 0080h to 00FFh of the logical addresses, and File B stored in page 096 to page 127 is valid data. In the second L2P table 400b, page 128 to page 159 of the physical addresses are mapped to 0100h to 017Fh of the logical addresses, and File C stored in page 128 to page 159 is valid data. Page 160 to page 191 of the physical addresses are mapped to 0180h to 027Fh of the logical addresses, and File D stored in page 160 to page 191 is valid data. Page 192 to page 256 of the physical addresses of the second L2P table 400b and the physical addresses of each page of the third L2P table 400c are pages that have no mapping with logical addresses, and are reusable erased pages (EPS).

### <5-4. Operating Method of Memory System 1>

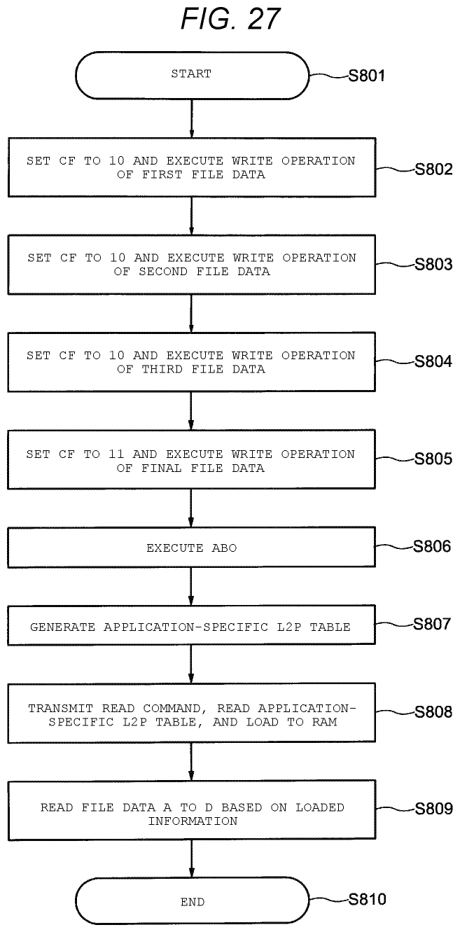

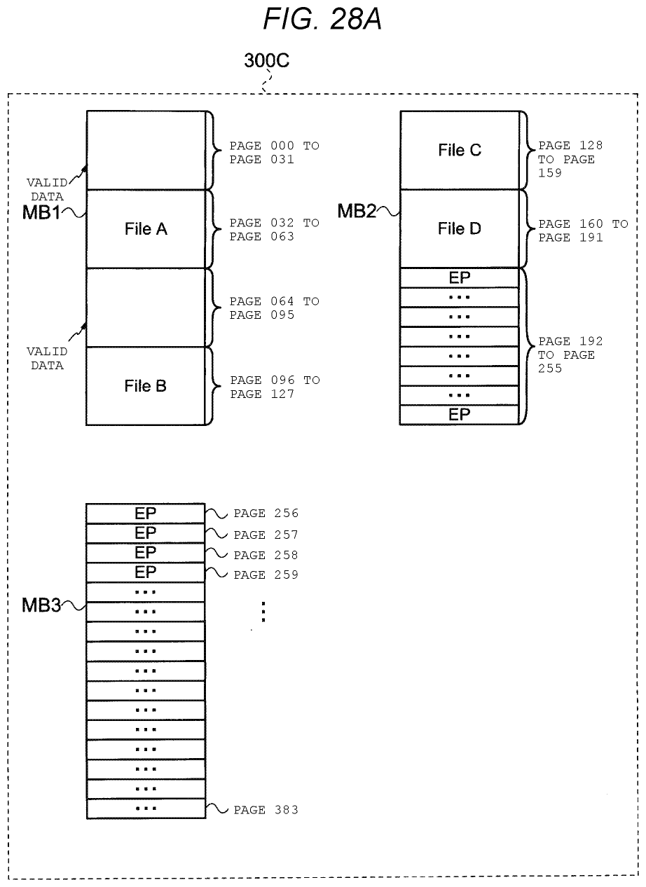

The operating method of the memory system 1 according to the fifth embodiment will be described with reference to FIGS. 27 to 29. FIG. 27 is a flowchart showing the operating method of the memory system 1 according to the fifth embodiment. FIG. 28C is a diagram showing a configuration of the actual data unit 300C according to the fifth embodiment, and FIG. 28D is a diagram showing a configuration of the table unit 400C according to the fifth embodiment. FIG. 29 is a diagram showing the configuration of the table unit 400C according to the fifth embodiment.

The operating method of the memory system 1 according to the fifth embodiment will be described with reference to FIG. 27. First, the memory system 1 starts the operating method of the memory system 1 according to the fifth embodiment (step S801).

Next, the memory controller 10 stores File A in page 032 to page 063 of the non-volatile memory 20 following page 000 to page 031 of the memory block MB1 in which valid data is stored, based on the write operation explained in “1-7. Second Example of Operating Method of Memory System 1 (Second Example)” (step S802).

Like in step S802, the memory controller 10 executes steps S803 to S805, stores File B in page 096 to page 127 of the memory block MB1 following page 064 to page 095 of the memory block MB1 in which valid data is stored, stores File C in page 128 to page 159 of the memory block MB2, and stores File D in page 160 to page 191 of the memory block MB2 following page 160 to page 191 of the memory block MB2 in which valid data is stored. The states of the actual data unit 300C and the table unit 400C at the end of step S805 are the states shown in FIGS. 28A and 28B. In step S805, the memory controller 10 receives the write command WCMD including the CF data (11). Therefore, the memory controller 10 executes the ABO process based on the CF data (11) (step S806). The data management unit 110 stores File A to File D in the order of LBA 0000h to 027Fh in page 192 to page 255 of the memory block MB2 and page 256 to page 319 of the memory block MB3 via the memory I/F. That is, the data management unit 110 stores File A to File D in the order of LBA in the pages corresponding to continuous physical addresses of the non-volatile memory 20. Here, the data management unit 110 invalidates File A stored in page 032 to page 063 of the memory block MB1, File B stored in page 096 to page 127 of the memory block MB1, and File C and File D stored in page 128 to page 191 of the memory block MB2 to be not mapped to logical addresses. The state of the actual data unit 300C at the end of step S807 is the state shown in FIG. 28C.

Here, the data management unit 110 maps LBA 0000h to 00FFh of the memory block MB1 to page 192 to page 255 of the physical addresses and stores the mapping in the second L2P table 400b, and maps LBA 0100h to 027Fh to page 256 to page 319 of the physical addresses and stores the mapping in the third L2P table 400c. The data management unit 110 invalidates File A stored in page 032 to page 065 of the physical addresses corresponding to 0000h to 007Fh of the logical addresses and File B stored in page 096 to page 127 of the physical addresses corresponding to the 0080h to 00FFh of the logical addresses in the first L2P table 400a. The data management unit 110 invalidates File C and File D stored in page 128 to page 191 of the physical addresses corresponding to 0100h to 027Fh of the logical addresses in the second L2P table 400b. The state of the table unit 400C at the end of step S807 is the state shown in FIG. 28D. In the fifth embodiment, the mapping of the LBA of invalid data (shaded area) may not exist, and mapping indicating that the LBA of the first L2P table 400a, the second L2P table 400b, and the third L2P table 400c is EP may not exist.

Next, upon receiving completion of the ABO process, the data management unit 110 reads and executes the program 116 to generate the application-specific L2P table 410 in the non-volatile memory 20 (step S807).

The data management unit 110 maps LBA 0000h to 027Fh of File A to File D with page 192 to page 319 corresponding to the physical addresses and stores the mapping in the application-specific L2P table 410. The state of the table unit 400C at the end of step S807 is the state shown in FIG. 29.

Next, the data management unit 110 receives a read request including the read command RCMD from the host 30, reads the application-specific L2P table 410 from the non-volatile memory 20, and loads the read table onto the RAM 12 (step S808).

The data management unit 110 may read File A to File D stored in page 192 to page 319 of the non-volatile memory 20 in this order based on the application-specific L2P table 410 loaded onto the RAM 12 (step S809).

When the memory system 1 executes the read operation and step S809 is completed, the operation of the memory system 1 according to the fifth embodiment ends (step S810).

The operating method of the memory system 1 according to the fifth embodiment includes managing File A to File D over two L2P tables at the end of step 806, for example. A state in which the memory system 1 manages File A to File D over two L2P tables may occur even after the GC process. For example, when reading File A to File D at the end of step 806, the data management unit 110 needs to read each of the second L2P table 400b and the third L2P table 400c from the non-volatile memory 20 and load the read tables onto the RAM 12. That is, on the RAM 12, the second L2P table 400b and the third L2P table 400c are exchanged. Here, the data read time increases and the read operation is slow.

Meanwhile, the operating method of the memory system 1 according to the fifth embodiment includes generating the application-specific L2P table 410 in the non-volatile memory 20 in step S807. As a result, when reading File A to File D, the data management unit 110 reads the application-specific L2P table 410 from the non-volatile memory 20 and loads the read table onto the RAM 12, thereby reducing the time required to exchange the L2P table. Therefore, the operating method of the memory system 1 according to the fifth embodiment can shorten the data read time and speed up the read operation.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system, comprising:
a non-volatile memory including a plurality of pages; and
a memory controller configured to write a plurality of data portions into the non-volatile memory, wherein the data portions are specified based on a plurality of write commands received from a host, respectively, wherein
the host assigns same setting information to the plurality of write commands, and
the memory controller is configured to write the plurality of data portions to a plurality of pages, respectively, wherein the plurality of pages correspond to a plurality of continuous addresses among the plurality of pages based on the same setting information.

2. The memory system according to claim 1, wherein the plurality of data portions include at least a first data portion and a second data portion,
the same setting information includes a first flag, and
the first flag is assigned to the second data an indication indicating that the second data is continuous to the first data.

3. The memory system according to claim 2, wherein the plurality of data portions further include a third data portion, and
the first flag is assigned to the third data portion an indication indicating that the third data portion is continuous to the second data portion and the third data portion is a last data portion.

4. The memory system according to claim 1, wherein, after collecting garbage, the memory controller is configured to executes a process of writing into the plurality of pages corresponding to the plurality of continuous addresses.

5. The memory system according to claim 1, wherein the plurality of data portions include at least a first data portion and a second data portion,
the same setting information includes a second flag,
the second flag includes setting information indicating that the plurality of data portions belong to a same group, and
the second flag is assigned to the second data portion an indication indicating that the second data portion is continuous to the first data portion.

6. The memory system according to claim 5, wherein the second flag includes setting information indicating an order of reading the plurality of data portions from the non-volatile memory.

7. The memory system according to claim 1, wherein the plurality of data portions include at least a first data portion and a second data portion, and
the same setting information includes an operation code indicating that the first data portion and the second data portion are concatenated, a start address of the first data portion, and a start address of the second data portion.

8. The memory system according to claim 7, wherein the start address of the first data portion is smaller than the start address of the second data portion, and
the memory controller is configured to write the first data portion before the second data portion, and read the first data portion before the second data portion.

9. A memory system connectable to a host, the memory system comprising:
a non-volatile memory including a plurality of pages; and
a memory controller configured to write a plurality of data portions into the non-volatile memory, wherein the data portions are specified by a plurality of write commands received from a host, respectively, wherein
the host assigns setting information belonging to a same group to each of the plurality of write commands, and
the memory controller is configured to:
write the plurality of data portions to a plurality of pages which correspond to a plurality of continuous addresses among the plurality of pages, respectively, based on the setting information belonging to the same group; and
after writing the data portions, periodically read a file system stored in the non-volatile memory, analyze the file system, and acquire a time stamp included in the file system.

10. The memory system according to claim 9, wherein, when determining that the time stamp included in the file system is a newly recorded time stamp or an updated time stamp, the memory controller is configured to store time information corresponding to the time stamp in the non-volatile memory.

11. The memory system according to claim 10, wherein the memory controller is configured to read the time information and check updated data among the plurality of data portions and a page in which the updated data is written.

12. A method, comprising:
executing a write operation that includes writing a plurality of data portions into the non-volatile memory, wherein the data portions are specified by a plurality of write commands received from a host, respectively, wherein
same setting information is assigned to each of the plurality of write commands, and
the write operation further includes writing the plurality of data portions to a plurality of pages, respectively, wherein the plurality of pages correspond to a plurality of continuous addresses among the plurality of pages based on the same setting information.

13. The method according to claim 12, wherein the plurality of data portions include at least a first data portion and a second data portion,
the same setting information includes a first flag, and
the first flag is assigned to the second data an indication indicating that the second data is continuous to the first data.

14. The method according to claim 13, wherein the plurality of data portions further include a third data portion, and
the first flag is assigned to the third data portion an indication indicating that the third data portion is continuous to the second data portion and the third data portion is a last data portion.

15. The method according to claim 12, wherein, after collecting garbage, the memory controller is configured to executes a process of writing into the plurality of pages corresponding to the plurality of continuous addresses.

16. The method according to claim 12, wherein the plurality of data portions include at least a first data portion and a second data portion,
the same setting information includes a second flag,
the second flag includes setting information indicating that the plurality of data portions belong to a same group, and
the second flag is assigned to the second data portion an indication indicating that the second data portion is continuous to the first data portion.

17. The method according to claim 16, wherein the second flag includes setting information indicating an order of reading the plurality of data portions from the non-volatile memory.

18. The method according to claim 12, wherein the plurality of data portions include at least a first data portion and a second data portion, and
the same setting information includes an operation code indicating that the first data portion and the second data portion are concatenated, a start address of the first data portion, and a start address of the second data portion.

19. The method according to claim 18, wherein the start address of the first data portion is smaller than the start address of the second data portion, and
the first data portion is written before the second data portion, and the first data portion is read before the second data portion.
